(19) United States
(12) Patent Application Publication
(10) Pub. No.: US 2008/0225304 A1
(43) Pub. Date: Sep. 18, 2008

(54) Optical scanning unit and image forming apparatus using same

(75) Inventors: Yoshinobu Sakaue, Tokyo (JP); Noboru Kusunose, Yokohama city (JP); Hideto Higaki, Yokohama city (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/073,884

(22) Filed: Mar. 11, 2008

(30) Foreign Application Priority Data
Mar. 12, 2007 (JP) 2007-062015

(51) Int. Cl. G01B 11/14

(52) U.S. Cl. 356/622

(57) ABSTRACT

An optical scanning unit includes first and second light beam generators, a deflector, a beam detector, and an optical element. The first and second light beam generators respectively emit a first and second light beam. The deflector deflects the first and second light beams in a main scanning direction and to scan a surface of first and second photosensitive members using the first and second light beams respectively. The beam detector detects both of the first and second light beams deflected by the deflector. The beam detector detects a light beam position of the first and second light beams in a sub-scanning direction. The optical element is disposed along an optical path for the first and second light beams starting from the first and second light beam generators to the deflector to set a light incoming angle striking the deflector same for the first and second light beams.

### CROSS-REFERENCE TO RELATED APPLICATIONS

This application claims priority from Japanese Patent Application No. 2007-062015, filed on Mar. 12, 2007 in the Japan Patent Office, the entire contents of which are hereby incorporated by reference herein.

### BACKGROUND OF THE INVENTION

1. Field of the Invention

The present disclosure generally relates to an image forming apparatus having an optical scanning unit, which directs a light beam emitted from a light beam generator onto an image carrier by deflecting the light beam in a main scanning direction with a deflector to write a latent image on the image carrier.

2. Description of the Background Art

Typically, an image forming apparatus includes an optical scanning unit, which detects a light beam position in a sub-scanning direction, and corrects a writing start position depending on a change in relative positions of optical elements in the optical scanning unit. Such optical scanning unit has a correction unit for correcting the positions of the optical elements based on positional deviation data detected for light beams of each of colors yellow (Y), magenta (M), cyan (C), and black (K).

For example, such correction unit corrects a writing start position of a light beam based on detected positional deviation data for main scanning registration, sub-scanning registration, main scanning direction magnification, inclination in sub-scanning direction, and bending in sub-scanning direction for light beams of each of colors yellow (Y), magenta (M), cyan (C), and black (K). However, such optical scanning unit may need a beam detector for each of light beams of Y, M, C, and K, which increases the number of beam detectors and thus increases production cost of the optical scanning unit.

Further, another type of optical scanning unit has one beam detector (or sensor) used in common for a plurality of light beams, in which a position of each light beam is shifted in a main scanning direction to shift a timing with which each light beam reaches the single beam detector (hereinafter “reach timing”) so as to detect each light beam independently.

An advantage of such optical scanning units is that they can use a common optical element for detecting a plurality of light beams by shifting the light beam in a main scanning direction and by shifting a reach timing of each of the light beams reaching the common optical element such as a beam detector to detect a shifting of each light beam precisely. However, such optical scanning units may need a relatively large space for optical paths for the light beams directed to the common optical element, thereby increasing production costs of such optical scanning units.

In addition, generally, an image forming apparatus using a tandem type arrangement has a plurality of image carriers to form images of different colors as visible images, and such color images are superimposed on one another to form one full-color image. In such image forming apparatuses, each of the image carriers is irradiated by and scanned with a light beam corresponding to image information to form a latent image on the image carrier, thus developing the latent image as a visible image.

An optical scanning unit for scanning a light beam includes a polygon mirror and a plurality of optical elements (e.g., lenses). The polygon mirror deflects a light beam emitted from a light source to scan the image carrier with the deflected light beam. The plurality of optical elements is used to focus the light beam deflected by the polygon mirror on a surface of the image carrier.

In such optical scanning unit, relative positions of and angles of the optical elements may change slightly due to curvature of field of the optical elements, twisting of a housing of the optical scanning unit, thermal deformation of parts configuring the optical scanning unit by heat generated by a polygon mirror or motor, twisting of the image carrier when attaching the image carrier, and the like.

Changes in the relative positions and angles of the optical elements occur can change the scan position of the light beams on the image carrier, and further, can cause bending or inclination of a scanning line on the surface of the image carrier. As a result, such deviations in the relative scan positions of the light beams of the image carriers and such bending or inclination of the scanning line may appear as out-of-register colors. Such deviations in the relative scan positions of the image carriers in a sub-scanning direction in particular may cause out-of-register colors.

Detection of extent of relative scan position deviation among the image carriers in a sub-scanning direction, which is necessary to correct such deviation accurately, may be accomplished as follows.

First, an image pattern (or registration mark image) is formed on a transfer member such as an image carrier or an intermediate transfer belt, and a sensor is used to detect a position of the image pattern on the image carriers. Then, based on a detection result of the sensor, a correction (or registration correction) of scan position in a sub-scanning direction is conducted.

However, in such correction method, if the transfer member (e.g., image carrier or intermediate transfer belt) has scratches or blemishes on its face or foreign matter adhering thereto, the image pattern may not be correctly formed on the transfer member. As a result, either the image pattern cannot be detected or the correction result may not be suitable even if the image pattern can be detected. Further, because a sensor for detecting an image pattern is disposed in proximity to the transfer member, the sensor may be contaminated by toner or the like scattering from the transfer member, by which an image pattern may not be detected correctly. Further, when forming and detecting an image pattern, an image forming operation cannot be conducted, which may be result in downtime for an image forming apparatus.

### SUMMARY

The present disclosure relates to an optical scanning unit for use with a first photosensitive member and a second photosensitive member. The optical scanning unit includes a first light beam generator, a second light beam generator, a deflector, a beam detector, and an optical element. The first light beam generator emits a first light beam. The second light beam generator emits a second light beam. The deflector deflects the first and second light beams in a main scanning direction and to scan a surface of the first and second photosensitive members using the first and second light beams respectively. The beam detector detects both of the first and second light beams deflected by the deflector. The beam detector detects a light beam position of the first and second light beams in a sub-scanning direction. The optical element is disposed at a given position along an optical path for the first and second light beams starting from the first and second light beam generators to the deflector to set a light incoming angle striking the deflector same for the first and second light beams. The incoming angle is defined by a light axis direction of either the first light beam or the second light beam and a normal line extending from the surface of either the first photosensitive member or the second photosensitive member.

The present disclosure also relates to an image forming apparatus having a first photosensitive member, a second photosensitive member, and an optical scanning unit. The optical scanning unit includes a first light beam generator, a second light beam generator, a deflector, a beam detector, and an optical element. The first light beam generator emits a first light beam. The second light beam generator emits a second light beam. The deflector deflects the first and second light beams in a main scanning direction and to scan a surface of the first and second photosensitive members using the first and second light beams respectively. The beam detector detects both of the first and second light beams deflected by the deflector. The beam detector detects a light beam position of the first and second light beams in a sub-scanning direction. The optical element is disposed at a given position along an optical path for the first and second light beams starting from the first and second light beam generators to the deflector to set a light incoming angle striking the deflector same for the first and second light beams. The incoming angle is defined by a light axis direction of either the first light beam or the second light beam and a normal line extending from the surface of either the first photosensitive member or the second photosensitive member.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a schematic configuration of an image forming apparatus according to an example embodiment;

FIG. 2 illustrates a schematic configuration of an optical scanning unit of the image forming apparatus in FIG. 1;

FIG. 3 illustrates a schematic configuration the optical scanning unit of FIG. 2, view from a bottom side;

FIG. 4 illustrates a perspective view of an optical system of the optical scanning unit, to which an incoming light enters;

FIG. 5 illustrates a schematic configuration of a beam detection unit of the optical scanning unit;

FIG. 6 illustrates a schematic configuration of a beam detection unit having a function of detecting light beam position in a sub-scanning direction;

FIG. 7 illustrates a schematic configuration of a shutter for the optical scanning unit;

FIG. 8 is a block diagram for out-of-register colors correction unit provided for the optical scanning unit;

FIG. 9 is a flow chart for out-of-register colors correction by the out-of-register colors correction unit;

FIGS. 10 to 12 are another flow chart for out-of-register colors correction;

FIG. 13 illustrates a schematic configuration of a deflection device for sub-scanning direction;

FIG. 14 illustrates a schematic configuration of an optical scanning unit having a deflection device for sub-scanning direction;

FIG. 15 illustrates a schematic configuration of a deflection device for sub-scanning direction having a liquid crystal element;

FIG. 16 illustrates a schematic configuration of another deflection device for sub-scanning direction having another liquid crystal element;

FIG. 17 illustrates a schematic configuration of another deflection device for sub-scanning direction having another liquid crystal element;

FIG. 18 illustrates a schematic configuration of a deflection device for sub-scanning direction having a parallel plate;

FIG. 19 illustrates a perspective view of the deflection device for sub-scanning direction of FIG. 18;

FIG. 20 illustrates a schematic configuration of another deflection device for sub-scanning direction having another parallel plate;

FIG. 21 illustrates a schematic configuration of another deflection device for sub-scanning direction;

FIG. 22 illustrates a schematic configuration of another deflection device for sub-scanning direction;

FIG. 23 illustrates a schematic configuration of another deflection device for sub-scanning direction;

FIG. 24 illustrates a schematic configuration of the deflection device for sub-scanning direction of FIG. 23, in which a laser diode unit is moved to shift a laser irradiation position;

FIG. 25 illustrates a movement of light beam in a sub-scanning direction in a configuration of FIG. 24;

FIG. 26 illustrates voltage pulse pattern applied to a deflection element;

FIG. 27 illustrates a perspective view of a scanning line inclination adjuster for correcting scanning line inclination; and

FIGS. 28 and 29 are partially expanded views of the scanning line inclination adjuster of FIG. 27.

The accompanying drawings are intended to depict example embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXAMPLE EMBODIMENTS

A description is now given of example embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing expanded views shown in the drawings, specific terminology is employed for the sake of clarity, the present disclosure is not limited to the specific terminology so selected and it is to be understood that each specific element includes all technical equivalents that operate in a similar manner.

Referring now to the drawings, an image forming apparatus according to an example embodiment is described with reference to accompanying drawings. The image forming apparatus may employ electrophotography, for example, and may be used as copier, printer, facsimile, or a multi-functional apparatus, but not limited thereto.

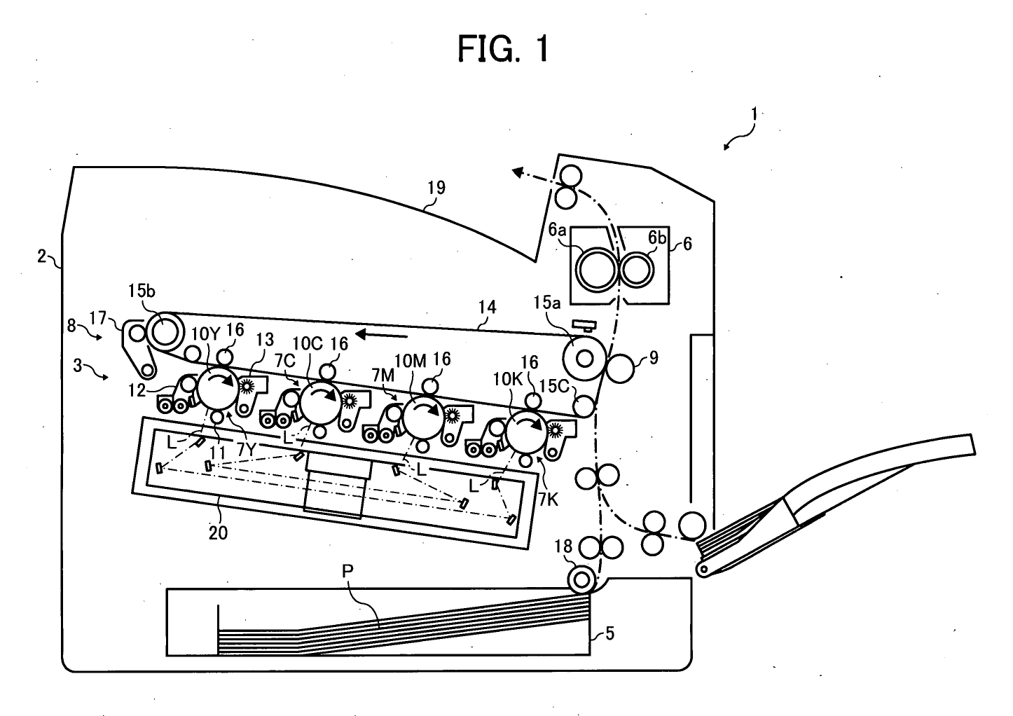

FIG. 1 illustrates a schematic configuration of an image forming apparatus 1 according to an example embodiment. The image forming apparatus 1 includes a housing 2, image forming engines 7Y, 7C, 7M, and 7K for yellow, cyan, magenta, and black color arranged in a tandem manner, and an intermediate transfer unit 8 disposed over the image forming engines 7Y, 7C, 7M, and 7K. Each of the image forming engines 7Y, 7C, 7M, and 7K respectively includes photoconductors 10Y, 10C, 10M, and 10K having a drum shape as image carrier. Hereinafter, suffix letters of Y, C, M, and K represent colors of yellow, cyan, magenta, and black, respectively.

As illustrated in FIG. 1, the intermediate transfer unit 8 includes an intermediate transfer belt 14, extended and driven by support rollers 15a, 15b, and 15c in a direction shown by an arrow. The image forming engines 7Y, 7C, 7M, and 7K are disposed under the intermediate transfer belt 14 by setting a given interval between the image forming engines. The arrangement order of the image forming engines 7Y, 7C, 7M, and 7K can be changed depending on a design concept.

When forming a full-color image, each of toner color images is formed on the photoconductors 10Y, 10C, 10M, and 10K of the image forming engines 7Y, 7C, 7M, and 7K, which will be described later. Then, each of toner color images having different color are sequentially transferred and superimposed on the intermediate transfer belt 14 with an effect of a primary transfer roller 16 when the intermediate transfer belt 14 travels in one direction. The primary transfer roller 16 faces the photoconductor 10 via the intermediate transfer belt 14. Specifically, such toner image transfer is conducted at a transfer position set by the intermediate transfer belt 14 and the primary transfer roller 16.

The superimposed toner images transferred on the intermediate transfer belt 14 are then transferred to a recording medium at a secondary nip portion set by the support roller 15a and a secondary transfer roller 9. Then, the recording medium is transported to a space between fusing rollers 6a and 6b of a fusing unit 6, and ejected to an ejection tray 19 by a transport roller and an ejection roller, by which a full-color image is formed on the recording medium.

Further, the intermediate transfer belt 14 is configured be constantly contacted to the photoconductor 10K by the primary transfer roller 16 for a monochrome mode (black image mode). Other photoconductors 10Y, 10M, and 10C can be configured be separable from the intermediate transfer belt 14 by a movable tension roller when an image forming is conducted only by monochrome mode (black image mode). Further, the image forming apparatus 1 includes a belt cleaning unit 17 for removing toners remaining on the intermediate transfer belt 14 at a position facing the support roller 15b.

In such configuration, each of the image forming engines 7Y, 7C, 7M, and 7K has a similar configuration and image forming process except color of toners. Accordingly, an image forming process is described with the image forming engines 7Y as below.

As illustrated in FIG. 1, in the image forming engines 7Y, the photoconductor 10Y is surrounded with a charge roller 11, a developing unit 12, a cleaning unit 13, and the primary transfer roller 16, for example. The charge roller 11 charges the photoconductor 10Y. The developing unit 12 develops a latent image on the photoconductor 10Y.

The image forming apparatus 1 further includes the optical scanning unit 20. The optical scanning unit 20 includes a light source such as semiconductor laser, a coupling lens, a f-theta lens, a toroidal lens, a mirror, and a rotatable polygon mirror, for example. The optical scanning unit 20 emits a light beam L to each of the photoconductors 10. The optical scanning unit 20 scans or irradiates the light beam L to a writing position on the photoconductor 10Y to form a latent image (to be described later) on the photoconductor 10Y.

Then, the developing unit 12 of the image forming engines 7Y develops the latent image as yellow image (or visible image) using developing agent having yellow color toner housed in the developing unit 12. The developing units 12 in other image forming engines 7 similarly develops the latent image as toner images (or visible images) using developing agent having respective color developing agent housed in the respective developing units 12.

When to conduct an image forming operation, the charge roller 11 uniformly charges the photoconductor 10Y, which is rotating, and the photoconductor 10Y is irradiated with the light beam L having yellow image information at a writing position to form a latent image, and then the latent image is developed as yellow toner by the developing unit 12

The yellow toner image on the photoconductor 10Y is then transferred to the intermediate transfer belt 14 with an effect of the primary transfer roller 16. The yellow toner image on the intermediate transfer belt 14 is sequentially superimposed with a cyan toner image formed in the image forming engine 7C, a magenta toner image formed in the image forming engine 7M, and a black toner image formed in the image forming engine 7B when cyan, magenta, black toner images are transferred to the intermediate transfer belt 14. With such process, a full color toner image is form on the intermediate transfer belt 14.

At a same timing that the superimposed toner image comes to a position facing the secondary transfer roller 9, a recording medium P is fed to a position facing the secondary transfer roller 9. Specifically, the recording medium P stored in a sheet feed unit 5 is fed to a registration roller by a sheet feed roller 18, and the registration roller feeds recording medium P at the secondary nip portion set by the support roller 15a and the secondary transfer roller 9 at a given timing to transfer the superimposed toner image from the intermediate transfer belt 14 to the recording medium P.

After transferring toner image, toners remaining on the photoconductor 10 is removed by the cleaning unit 13, and then de-charged by a de-charging lamp to prepare for a next image forming operation. Similarly, toners remaining on the intermediate transfer belt 14 is removed by the belt cleaning unit 17.

In the above described configuration for the image forming apparatus 1, toner images on each of the photoconductors 10Y, 10C, 10M, and 10K are superimposingly transferred on the intermediate transfer belt 14, and such superimposed toner images are transferred to the recording medium P.

Further, instead of using the intermediate transfer belt 4, the image forming apparatus 1 may be provided with a recording medium transport belt, in which a recording medium is directly, superimposingly, and sequentially transferred with toner images from each of the photoconductors 10 when the recording medium is transported by the recording medium transport belt, by which a full-color image is formed on the recording medium. The image forming apparatus 1 can employ such configurations.

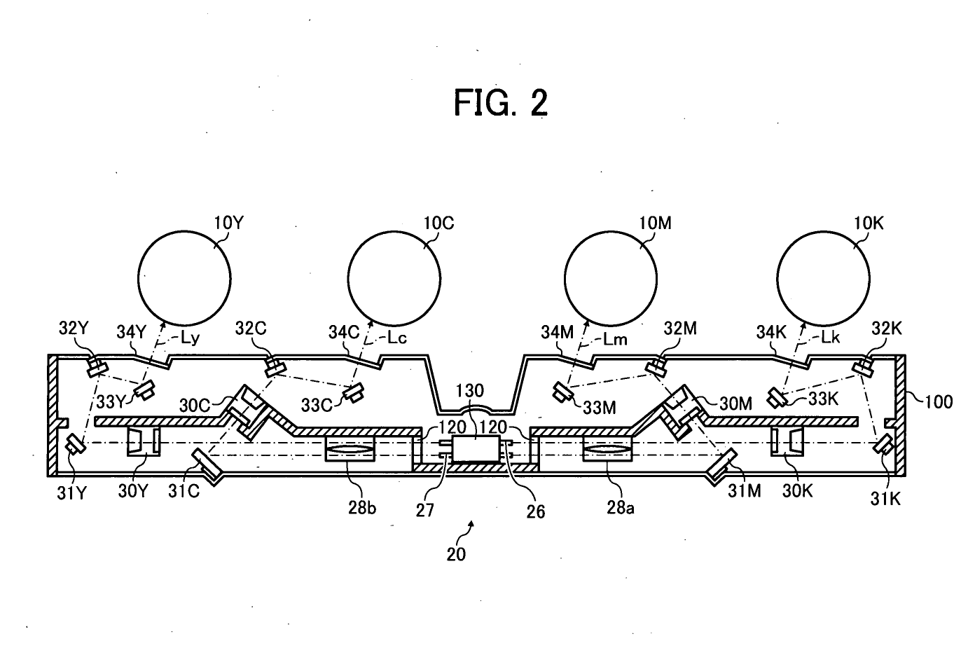

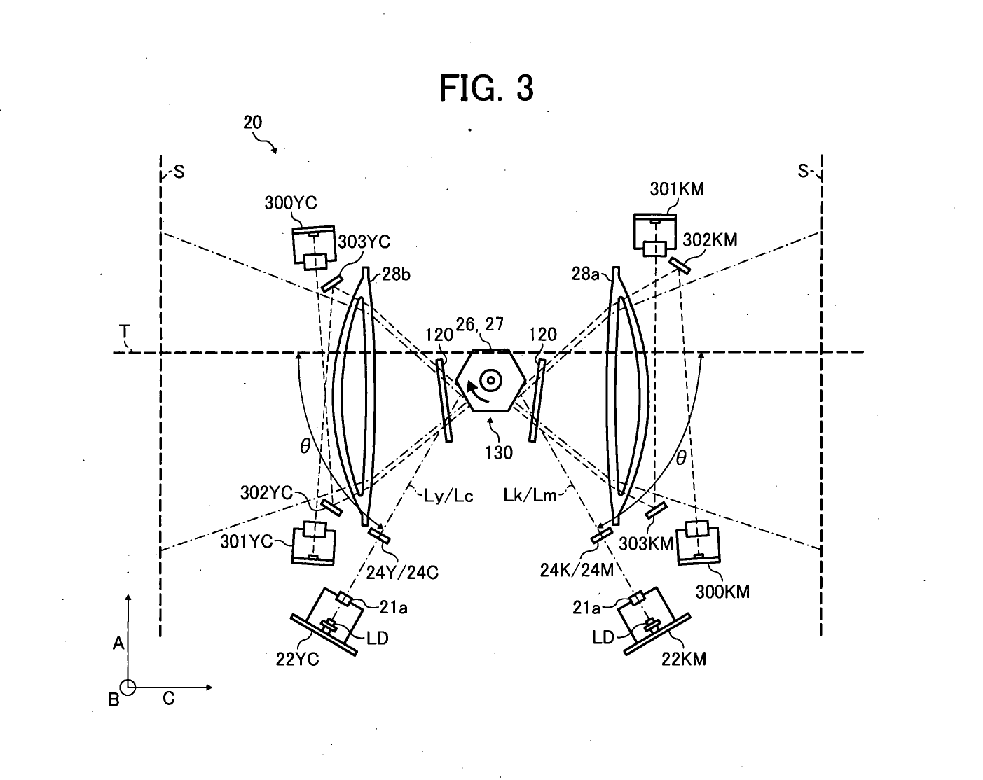

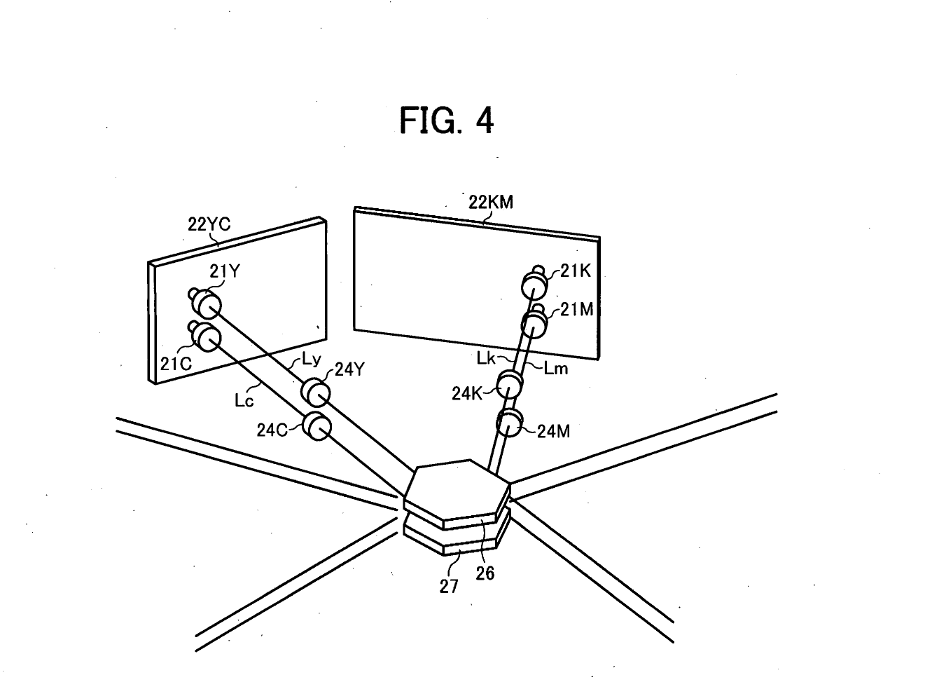

FIG. 2 illustrates an expanded view of the optical scanning unit 20 employed in the image forming apparatus 1 shown in FIG. 1. FIG. 3 illustrates a bottom view of the optical scanning unit 20. The optical scanning unit 20 shown in FIG. 2 and FIG. 3 is a tandem type optical system using a scan lens method. However, instead of the scan lens method, a scan mirror method can be employed. FIG. 4 illustrates a perspective view of a polygon mirror of the optical scanning unit 20.

The optical scanning unit 20 includes a polygon scanner 130, and optical elements such as reflection mirrors, lenses, or the like, for example. The polygon scanner 130 is used to deflect light beams in a main scanning direction for image forming. The polygon scanner 130, disposed at a center of the optical scanning unit 20, includes an upper polygon mirror 26 and a lower polygon mirror 27 fixed to a motor shaft of a polygon motor (not shown). Such configured polygon scanner 130 is surrounded with a soundproof glass 120.

As illustrated in FIG. 2, an optical system for M and an optical system for K are disposed at the right side of the polygon scanner 130 in FIG. 2, and an optical system for Y and an optical system for C are disposed at the left side of the polygon scanner 130 in FIG. 2, for example. Accordingly, the optical systems for Y/C are symmetrical to the optical systems for K/M about an axis of rotation of the motor shaft of the polygon motor.

As illustrated in FIGS. 3 and 4, the optical scanning unit 20 includes light source units 21K, 21M, 21C, and 21Y used as light beam generators. The light source units 21K, 21M, 21C, and 21Y respectively emits light beams Lk, Lm, Lc, and Ly to the photoconductors 10K, 10M, 10C, and 10Y. As illustrated in FIG. 4, the light source units 21K and 21M are positioned at a same position with respect to a horizontal direction when the light source units 21K and 21M are viewed from a vertical direction while having different height positions. Similarly, the light source units 21Y and 21C are positioned at a same position with respect to a horizontal direction when the light source units 21Y and 21C are viewed from a vertical direction while having different height positions. Each of the light source units 21 at least includes a light source such as semiconductor laser LD and a collimate 21a.

Further, as illustrated in FIG. 4, the light source units 21K and 21M are attached to and supported by a control board 22KM. Similarly, the light source units 21C and 21Y are attached to and supported by a control board 22YC, for example.

Further, as illustrated in FIG. 4, optical elements such as cylinder lens 24K, 24M, 24C, and 24Y are respectively disposed along an optical path of light beam between the light source unit 21 and the polygon scanner 130. Although not shown, a reflection mirror can be provided along the optical path of light beam between the light source unit 21 and the polygon scanner 130.

Further, as illustrated in FIG. 2, optical elements are disposed along an optical path between the polygon scanner 130 and the photoconductors 10Y, 10M, 10, and 10K, wherein the photoconductor 10 is scanned or irradiated with a light beam. Such optical elements include scan lens 28a and 28b (or f-theta lens), first mirrors 31K, 31M, 31C, 31Y, second mirrors 32K, 32M, 32C, 32Y, third mirrors 33K, 33M, 33C, 33Y, and long lenses 30K, 30M, 30C, 30Y, for example.

As illustrated in FIG. 3, the optical scanning unit 20 further includes a first beam detection unit 300KM, a last beam detection unit 301KM, a first beam detection unit 300YC, and a last beam detection unit 301YC. The first beam detection units 300KM and 300YC are symmetrically positioned each other about an axis of rotation of the motor shaft of the polygon motor. The last beam detection units 301KM and 301YC are also symmetrically positioned each other about an axis of rotation of the motor shaft of the polygon motor.

The first beam detection unit 300KM detects the start of scanning by the light beams (or scan beams) Lm and Lk for K and M. The last beam detection unit 301KM detects the end of scanning by the light beams Lm and Lk for K and M. The first beam detection unit 300YC detects the start of scanning by the light beams Ly and Lc for Y and C. The last beam detection unit 301YC detects the end of scanning by the light beams Ly and Lc for Y and C.

The first beam detection units 300KM and 300YC detect the start of scanning by the light beams deflected by the polygon scanner 130 to determine a start position (or start timing) of writing (or scanning) light beams on a photoconductor in one main scanning direction. The last beam detection units 301KM and 301YC detect the end of scanning by the light beams deflected by the polygon scanner 130 to determine an end position of writing (or scanning) light beams on a photoconductor in the one main scanning direction.

Specifically, the first beam detection units 300KM and 300YC can be used to detect a synchronization timing of light beam in a main scanning direction and a light beam position in a sub-scanning direction, wherein an image writing process is started when the synchronization timing of light beam in a main scanning direction is determined. The last beam detection unit 301KM and 301YC can be used to measure a magnification of one scanning line in a main scanning direction and an inclination of one scanning line in a sub-scanning direction when used with the first beam detection units 300KM and 300YC. The start of one scanning line can be detected by the first beam detection units 300KM and 300YC at a first time, and the end of the one scanning line can be detected by the last beam detection unit 301KM and 301YC at a second time. By computing and comparing a time difference between the first time and second time with a given reference time, an extension or contraction of one scanning line in a main scanning direction can be detected as a magnification of one scanning line. Such beam detection units are described later in detail.

A light beam emitted from the light source unit 21K passes through an aperture (not shown) and is formed as the light beam Lk having a given beam shape. The light beam Lk passed through the aperture enters the cylinder lens 24K to correct an optical face tangle error of the light beam Lk. Then, the light beam Lk passed through the cylinder lens 24K passes through the soundproof glass 120 and enters a side face of the upper polygon mirror 26 of the polygon scanner 130. When the light beam Lk enters the side face of the upper polygon mirror 26, the light beam Lk is deflected in a main scanning direction by the upper polygon mirror 26.

Then, the light beam Lk, deflected by the upper polygon mirror 26, passes through the soundproof glass 120 again and enters the scan lens 28a (or f-theta lens). The light beam Lk inflected by the scan lens 28a is reflected by a reflection mirror 302KM and enters the first beam detection unit 300KM so that the first beam detection unit 300KM detects the start of scanning by the light beam Lk before the light beam Lk scans the photoconductor 10K.

When the first beam detection unit 300KM detects the start of scanning by the light beam Lk, a synchronization signal for the light beam Lk is generated and output. Based on the synchronization signal for light beam Lk, an output timing of light beam Lk from the light source unit 21K is adjusted to write an image of K corresponding to input image data for K. The light beam Lk, emitted based on input image data, passes through the cylinder lens 24K, and deflected by the upper polygon mirror 26 and enters the scan lens 28a. The light beam Lk entered the scan lens 28a passes through the long lens 30K, the first, second, and third mirrors 31K, 32K, and 33K, and is then guided to the photoconductor 10K to scan or irradiate a surface of the photoconductor 10K as illustrated in FIG. 2. After scanning the photoconductor 10K, the light beam Lk is reflected by a reflection mirror 303KM, and enters the last beam detection unit 301KM to detect the end of scanning by the light beam Lk.

Similarly, the light beam Lm, emitted from the light source unit 21M based on input image data, passes through the cylinder lens 24M, and is deflected by the lower polygon mirror 27. The light beam Lm deflected by the lower polygon mirror 27 passes through the scan lens 28a, and then is reflected by the reflection mirror 302KM as similar to the light beam Lk. Before scanning the photoconductor 10M, the light beam Lm can be guided to the first beam detection unit 300KM by reflecting the light beam Lm by the reflection mirror 302KM as similar to the light beam Lk to output a synchronization signal for the light beam Lm. However, because the light beam Lm and the light beam Lk can reach the first beam detection unit 300KM at a same timing due to a geometrical arrangement of optical elements used for the light beam Lm and the light beam Lk, a synchronization signal for the light beam Lk is preferably used as synchronization signal for the light beam Lm.

The light beam Lm, emitted based on image data and synchronized in a main scanning direction, passes through the cylinder lens 24M, the lower polygon mirror 27, the scan lens 28a, the first mirror 31M, the long lens 30M, the second and third mirrors 32M and 33M, and is then guided to the photoconductor 10M to scan or irradiate a surface of the photoconductor 10M as illustrated in FIG. 2. After scanning the photoconductor 10M, the light beam Lm is reflected by the reflection mirror 303KM, and enters the last beam detection unit 301KM to detect the end of scanning by the light beam Lm, wherein the reflection mirror 303KM is also used to reflect the light beam Lk as described above. Accordingly, the light beam Lm deflected by the polygon scanner 130 enters the first beam detection unit 300KM and the last beam detection unit 301KM as similar to the light beam Lk.

Similarly, the light beam Ly, emitted from the light source unit 21Y based on input image data, passes through the cylinder lens 24Y, and is then deflected by the upper polygon mirror 26. The light beam Lm deflected by the upper polygon mirror 26 passes through the scan lens 28b, and is then reflected by a reflection mirror 302YC. Before scanning the photoconductor 10Y, the light beam Ly is guided to the first beam detection unit 300YC by reflecting the light beam Ly by the reflection mirror 302YC to output a synchronization signal for the light beam Ly.

The light beam Ly, emitted based on image data and synchronized in a main scanning direction, passes through the cylinder lens 24Y, the upper polygon mirror 26, the scan lens 28b, the long lens 30Y, the first, second, and third mirrors 31Y, 32Y, 33Y is then guided to the photoconductor 10Y to scan or irradiate a surface of the photoconductor 10Y as illustrated in FIG. 2. After scanning the photoconductor 10Y, the light beam Ly is reflected by a reflection mirror 303YC, and enters the last beam detection unit 301YC to detect the end of scanning by the light beam Ly.

Similarly, the light beam Lc, emitted from the light source unit 21C based on input image data, passes through the cylinder lens 24C, and is then deflected by the lower polygon mirror 27. The light beam Lc deflected by the lower polygon mirror 27 passes through the scan lens 28b, and is reflected by the reflection mirror 302YC as similar to the light beam Ly. Before scanning the photoconductor 10C, the light beam Lc can be guided to the first beam detection unit 300YC by reflecting the light beam Lc by the reflection mirror 302YC as similar to the light beam Ly to output a synchronization signal for the light beam Lc. However, because the light beam Lc and the light beam Ly can reach the first beam detection unit 300YC at a same timing due to a geometrical arrangement of optical elements used for the light beam Lc and the light beam Ly, a synchronization signal for the light beam Ly is preferably used as synchronization signal for the light beam Lc.

The light beam Lc, emitted based on image data and synchronized in a main scanning direction, passes through the cylinder lens 24C, the lower polygon mirror 27, the scan lens 28b, the first mirror 31C, the long lens 30C, the second and third mirrors 32C and 33C is then guided to the photoconductor 10C to scan of irradiate a surface of the photoconductor 10C as illustrated in FIG. 2. After scanning the photoconductor 10C, the light beam Lc is reflected by the reflection mirror 303YC and enters the last beam detection unit 301YC to detect the end of scanning by the light beam Lc as similar to the light beam Ly, wherein the reflection mirror 303YC is also used to reflect the light beam Ly as described above. Accordingly, the light beam Lc deflected by the polygon scanner 130 enters the first beam detection unit 300YC and the last beam detection unit 301YC as similar to the light beam Ly.

In such configuration, a synchronization signal for the light beam Lk is also used as a synchronization signal for the light beam Lm, and a synchronization signal for the light beam Ly is also used as a synchronization signal for the light beam Lc. Accordingly, a synchronization signal for one light beam (e.g., light beam Lk) can be used for another light beam (e.g., light beam Lm), and a synchronization signal for one light beam (e.g., light beam Ly) can be used for another light beam (e.g., light beam Lc), for example. Further, light beams used for determining a synchronization signal can be switched from one light beam to another light beam. Although a registration of another light beam in a main scanning direction may deviate due to parts tolerance deviation, attachment tolerance deviation or the like, such deviation can be corrected by a known color position correction method for detecting a detection pattern formed on an intermediate transfer belt for detecting positional deviation, for example.

In the above described configuration, two light beam generators of the light source units 21K and 21M are disposed at a given same position with respect to a horizontal direction when the light source units 21K and 21M are viewed from a vertical direction so that the light beams Lk and Lm are emitted to a same direction.

In such configuration as illustrated in FIG. 3, the two light source units 21K and 21M (light source units 21K/21M) emit the light beams Lk and Lm (light beams Lk/Lm), and light beams Lk/Lm enter the polygon scanner 130, in which the light beams Lk/Lm enter the polygon scanner 130 with an incoming angle θ with respect to a normal line T of a surface of the photoconductor 10 (i.e., a scan face S in FIG. 3). To make the incoming angle θ same for the two light beams Lk/Lm emitted from the light source units 21K/21M, optical elements are disposed along an optical path for the light beams Lk/Lm between the light source units 21K/21M and the polygon scanner 130, wherein the optical path takes a variety of arrangement patterns depending on a layout of apparatus.

For example, as illustrated in FIG. 3, optical elements disposed along the optical path for the light beams Lk/Lm between the light source units 21K/21M and the polygon scanner 130 may at least include the collimate lens 21, and the cylinder lens 24, wherein the light source units 21K/21M, the collimate lens 21, and the cylinder lens 24 can be substantially aligned in a light axis direction of the light source units 21K/21M. However, optical elements disposed along the optical path for the light beams Lk/Lm may not be limited thereto, but the optical path can be arranged in different manners. The optical path may be arranged in view of compacting a size of optical scanning unit, avoiding a physical interference of optical elements or the like, for example. Optical elements used in such optical path may include a reflection mirror, and a prism, for example. With such optical elements, an optical path between a light source and a polygon mirror may be configured as follows: light source/collimate lens/cylinder lens/polygon mirror, light source/collimate lens/cylinder lens/reflection mirror/polygon mirror, light source/collimate lens/reflection mirror/cylinder lens/polygon mirror, light source/collimate lens/prism/cylinder lens/polygon mirror, and so on.

On one hand, two light beam generators of the light source units 21Y and 21C are disposed at a given same position with respect to a horizontal direction when the light source units 21Y and 21C are viewed from a vertical direction so that the light beams Ly and Lc are emitted to a same direction.

In such configuration, as illustrated in FIG. 3, the two light source units 21Y and 21C (light source units 21Y/21C) emit the light beams Ly and Lc (light beams Ly/Lc), and the light beams Ly and Lc (light beams Ly/Lc) enter the polygon scanner 130, in which the light beams light Ly/Lc enter the polygon scanner 130 with an incoming angle θ with respect to a normal line T of a surface of the photoconductor 10 (i.e., a scanned face S). To make the incoming angle θ same for the two light beams Ly/Lc emitted from the light source units 21Y/21C, an optical element is disposed along an optical path for the light beams Ly/Lc between the light source units 21Y/21C and the polygon scanner 130, wherein the optical path takes a variety of arrangement patterns depending on a layout of apparatus.

For example, as illustrated in FIG. 3, optical elements disposed along the optical path for the light beams Ly/Lc between the light source units 21Y/21C and the polygon scanner 130 may at least include the collimate lens 21, and the cylinder lens 24, wherein the light source units 21Y/21C, the collimate lens 21, and the cylinder lens 24 can be substantially aligned in a light axis direction of the light source units 21Y/21C. However, optical elements disposed along the optical path for the light beams Ly/Lc may not be limited thereto, but the optical path can be arranged in different manners. The optical path may be arranged in view of compacting a size of optical scanning unit, avoiding a physical interference of optical elements or the like, for example. Optical elements used in such optical path may include a reflection mirror, and a prism, for example. With such optical elements, an optical path between a light source and a polygon mirror may be configured as follows: light source/collimate lens/cylinder lens/polygon mirror, light source/collimate lens/cylinder lens/reflection mirror/polygon mirror, light source/collimate lens/reflection mirror/cylinder lens/polygon mirror, light source/collimate lens/prism/cylinder lens/polygon mirror, and so on.

A description is now given to the first beam detection units 300KM and 300YC for detecting the start of scanning by the light beam, and the last beam detection units 301KM and 301YC for detecting the end of scanning by the light beam. Because such beam detection units have a similar configuration one another, such beam detection units may be referred as beam detection unit 300 hereinafter.

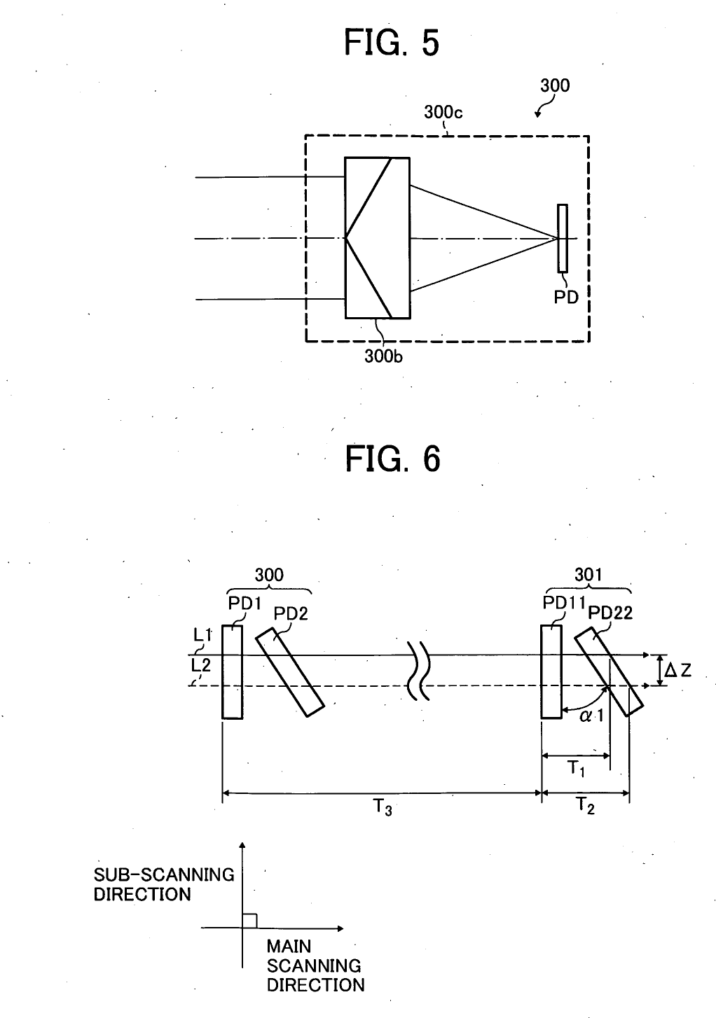

FIG. 5 illustrates a schematic configuration of the beam detection unit 300, which includes a light receiving element such as photodiode PD, a synchronization optical element 300b, a signal generator circuit board (not shown), and an element supporter 300c, for example. The photodiode PD, the synchronization optical element 300b, and the signal generator circuit board are supported by the element supporter 300c. The synchronization optical element 300b deflects a light beam entered to the first beam detection unit 300 in a sub-scanning direction, by which a light receiving element such as photodiode PD can be manufactured in compact size. The synchronization optical element 300b may be a prism, for example. Instead of prism, the synchronization optical element 300b may use a condenser lens to focus a light beam. However, if a condenser lens is used as the synchronization optical element 300b and the photodiode PD is disposed at a light focus position of the condenser lens, a deviation detection of light beam in a sub-scanning direction cannot be conducted. If the photodiode PD is disposed at a light focus position of the condenser lens, a deviated light beam is focused at a light focus position of the condenser lens, by which a deviation of light beam cannot be detected. Accordingly, an arrangement position of a light focus position of a condenser lens and the photodiode PD (used as light receiving element) is deviated each other.

The beam detection unit 300 has a function of detecting a light beam position in a sub-scanning direction in addition to a function of detecting a synchronization signal of light beam as described above.

A description is now given to a configuration of a beam detection unit for detecting a light beam position in a sub-scanning direction, in which numbers, arrangement position, shape of the photodiode PD is modified so that the beam detection unit can generate different signal depending on a light beam position in a sub-scanning direction.

FIG. 6 illustrates a beam detection unit having a function of detecting a light beam position in a sub-scanning line, in which the first beam detection unit 300 detects the start of scanning by the light beam, and the last beam detection unit 301 detects the end of scanning by the light beam.

As illustrated in FIG. 6, the beam detection unit 300 (301) includes a first light receiving element such as first photodiode PD1 (PD11) and a second light receiving element such as second photodiode PD2 (PD22). A light receiving face of the first photodiode PD1 (PD11) is set orthogonal to a light beam, incoming to the photodiode. A light receiving face of the second photodiode PD2 (PD22) is slanted with respect to the light receiving face of the first photodiode PD1 (PD11). The angle formed by the light receiving face of the first photodiode PD1 (PD11) and the light receiving face of the second photodiode PD2 (PD22) is set as inclination angle α1.

In such configuration, a first light beam L1 and a second light beam L2 pass through the first photodiode PD1 (PD11) and the second photodiode PD2 (PD22). The second light beam L2 is deviated from the first light beam L1 for ΔZ in a sub-scanning direction.

When the first light beam L1 and second light beam L2 pass through the pair of photodiodes (i.e., a pair of photodiodes PD1 and PD2, or a pair of photodiodes PD11 and PD22), the first light beam L1 passes through the pair of photodiodes at a first time T1, and the second light beam L2 passes through the pair of photodiodes at second time T2, wherein the first time T1 and second time T2 are different each other.

Accordingly, depending on light beam positions in a sub-scanning direction, a time when the first photodiode PD1 (PD11) detects a light beam and outputs a detection signal, and a time when the second photodiode PD2 (PD22) detects a light beam and outputs a detection signal becomes different.

By obtaining a time difference of “T2−T1” between the first and second times T1 and T2, a relative positional deviation of the second light beam L2 in a sub-scanning direction with respect to the first light beam L1 can be computed.

Because the angle α1 set by the light receiving faces of the PD1 (PD11) and PD2 (PD22) and the time difference of “T2−T1” can be set or computed as above described, a relative positional deviation ΔZ of a light beam in sub-scanning direction can be computed easily.

Such relative positional deviation ΔZ in a sub-scanning direction detected by the beam detection unit 300 (301) means a correction amount in a sub-scanning direction (referred as correction amount ΔZ, hereinafter). A sub-scanning line correction unit (to be described later) corrects the light beam deviation using the correction amount ΔZ.

Further, a time T3, which is a difference between a time that a light beam passes through the photodiode PD1 of the first beam detection unit 300 and a time that the light beam passes through the photodiode PD11 of the last beam detection unit 301, can be monitored. By detecting values of the time T3, a change of magnification in a main scanning direction can be monitored, in which the first beam detection unit 300 detects the start of scanning by the light beam and the last beam detection unit 301 detects the end of scanning by the light beam. By comparing the time T3 with a given reference time, an extension or contraction of one scanning line can be detected as a magnification of one scanning line.

Although a photodiode is used for the beam detection unit, other light receiving element device such as line CCD (charge-coupled device) can be used, for example.

By detecting one reflected light beam, reflected by mirror, at two positions (i.e., the start and end of the scanning by the light beam) using the above described beam detection unit, a magnification of one scanning line in a main scanning direction can be measured using, and a writing position of light beam in a main scanning direction at one end of a main scanning direction can be measured.

In the above described configuration, a plurality of light beams may enter one detection unit (i.e., beam detection unit 300, 301) at a different timing to respectively detect positions of the plurality of light beams in a sub-scanning direction.

A description is given with reference to FIG. 3. The light beams Lk/Lm emitted from the light source units 21K/21M enter the upper and lower polygon mirrors 26 and 27 with a same angle, respectively. Accordingly, the light beams Lk/Lm, respectively deflected by the upper and lower polygon mirrors 26 and 27, pass through the scan lens 28a, enter the reflection mirror 302KM, and reach the first beam detection unit 300KM at a same timing.

Accordingly, when correcting out-of-register colors in a sub-scanning direction, a positional deviation of light beam in a sub-scanning direction can be detected by emitting any one of the light beams Lk/Lm from the light source units 21K/21M. Such process is similarly applied to light beams Ly/Lc.

Further, instead of using the reflection mirror 302 (303), the beam detection unit 300 (301) may be arranged in a position so that a light beam passed through the scan lens 28 can directly enter the beam detection unit 300 (301).

Further, a light beam may be guided to the beam detection unit 300 (301) by reflecting different light beams using different reflection mirrors, respectively. However, if different reflection mirrors are used, a mirror attachment error may occur, by which a beam spot diameter on a light receiving element of the beam detection unit 300 (301) becomes different among light beams, which is not preferable. Further, a configuration that guides a light beam to the beam detection unit 300 (301) without passing the light beam through the scan lenses 28a and 28b can be employed.

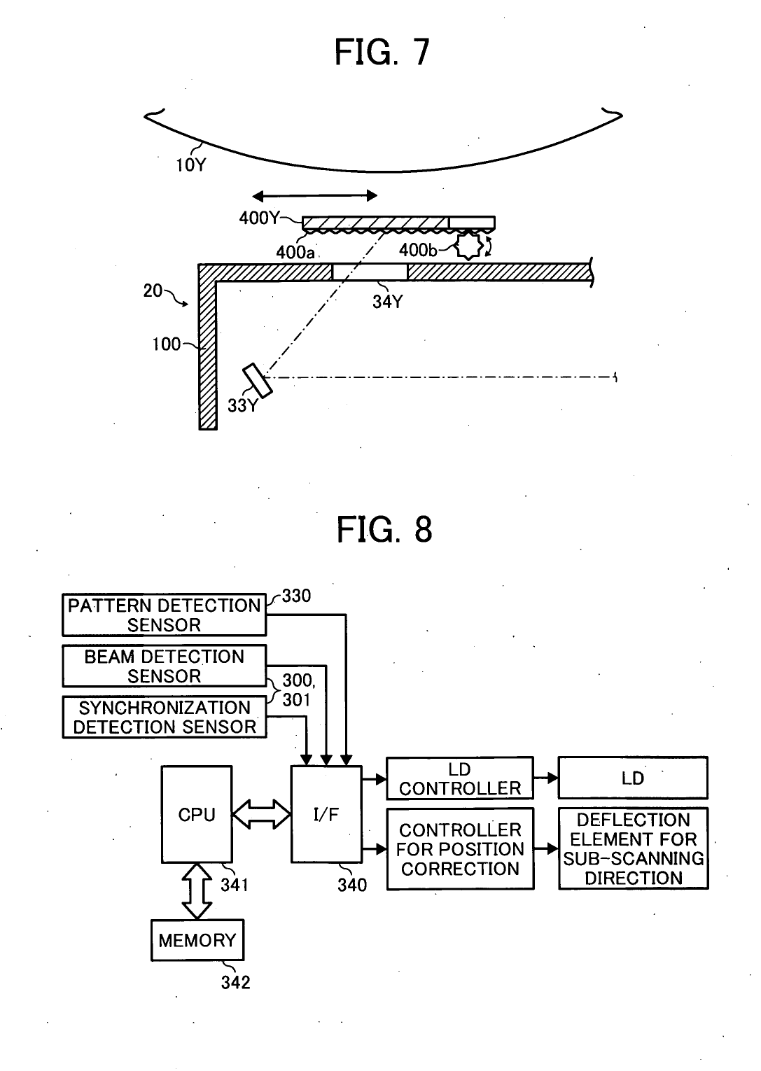

Further, as illustrated in FIG. 7, the optical scanning unit 20 includes a shutter 400. When correcting out-of-register colors (to be described later), the shutter 400 shields the dust-proof glasses 34K, 34M, 34C, and 34Y supported by a housing 100 (see FIG. 2) so that a light beam does not irradiate the photoconductors 10K to 10Y. A description is now given to the shutter 400Y for shielding the dust-proof glass 34Y because the shutter 400 has a similar mechanism for K, M, C, and Y.

The shutter 400Y can be moved in a direction parallel to the dust-proof glass 34Y. As illustrated in FIG. 7, the shutter 400Y is provided with a rack 400a at one face of the shutter 400Y. The rack 400a is meshed with a gear 400b, connected to a drive unit (not shown). When conducting out-of-register colors correction, the shutter 400Y covers the dust-proof glass 34Y so that the shutter 400Y shields a light beam from the photoconductor 10Y, by which light beam does not irradiate the photoconductor 10Y as illustrated in FIG. 7. Because a light beam does not irradiate the photoconductor 10Y when conducting out-of-register colors correction, an aging of the photoconductor 10Y by light beam can be suppressed.

When to form a latent image on the photoconductor surface, the drive unit (not shown) drives the gear 400b in a clockwise direction in FIG. 7. With such rotation of the gear 400b, the shutter 400Y moves in a right direction in FIG. 7 via the rack 400a meshed to the gear 400b. When the shutter 400Y passes through the dust-proof glass 34Y (i.e., the shutter 400 is opened), the drive unit is stopped to stop a movement of the shutter 400Y.

When a latent image forming process on the photoconductor 10 is completed or when an image forming operation is completed, the drive unit is driven to rotate the gear 400b in a counter-clockwise direction in FIG. 7. When the gear 400b rotates in a counter-clockwise direction in FIG. 7, the shutter 400 moves in a left direction in FIG. 7, and cover the dust-proof glass 34Y. When the shutter 400Y is closed, the drive unit is stopped to stop a movement of the shutter 400Y.

As such, the shutter 400Y can be closed and covers the dust-proof glass 34Y when an image forming operation is not conducted, by which adhesion of dust or foreign particles to the dust-proof glass 34Y can be suppressed. Therefore, an occurrence of failed images such as white spot can be suppressed.

A description is now given to a method of correcting out-of-register color of monocolor image in a sub-scanning direction, wherein out-of-register color of monocolor image may be caused by a relative positional deviation of light beams in a sub-scanning direction. Generally, a temperature change in an optical scanning unit caused by heat generation of a polygon motor or ambient temperature change may slightly fluctuate a positional relationship and an angle relationship among optical elements in the optical scanning unit, by which a scan position of light beams of each monocolor on a photoconductor in a sub-scanning direction may fluctuate and an out-of-register colors may occur. As such, a temperature change may cause a registration fluctuation among color images, by which image quality may degrade.

One known method of correcting out-of-register colors includes following processes: First, a detection pattern is formed on a transfer member, and the detection pattern is detected by a sensor to measure an out-of-register color amount. Based on the out-of-register color amount, an image writing timing is adjusted so that out-of-register colors can be suppressed. A temperature change in an image forming apparatus or an external force application to an image forming apparatus slightly changes position or size of image forming units, and further changes position/size of parts in image forming units. The aforementioned correction method detects out-of-register color amount caused by such change, and corrects such out-of-register color. However, in order to clearly compute out-of-register color amount, a plurality of detection patterns may need to be formed and measured to obtain an average value of the out-of-register color amount while consuming a given time period and toners. Such toner consumption may not be preferable because such consumed toner cannot be used for image forming. Accordingly, such correction method may not be conducted when each one printing job is completed but may be conducted when a given number of image forming operation are conducted. For example, such correction may be conducted one time when image forming operations are conducted for 200 sheets. However, such correction timing may not be effective to suppress an image registration deviation among color images, gradually changing due to heat generation of a polygon motor during image forming operations, and such image registration deviation may degrade image quality.

In view of such drawback, in an example embodiment, the optical scanning unit 20 has a configuration to arrange the beam detection units 300 and 301 at a position so that the beam detection units 300 and 301 can receive and detect a light beam, which is to be irradiated to the photoconductor 10. Based on detection results of light beams by using beam detection units 300 and 301, out-of-register colors among color images can be corrected at an effective timing for maintaining a good level of image quality over time.

FIG. 8 illustrates block diagram of a correction unit for correcting out-of-register colors. As illustrated in FIG. 8, the correction unit includes a pattern detection sensor 330, the beam detection units 300 and 301, a CPU (central processing unit) 341, an interface (I/F) 340, a memory 342, for example.

When a detection mode is set, the CPU 341 receives a detection signal from the pattern detection sensor 330, and detection signals from the beam detection units 300 and 301 via the I/F 340. Based on such signals, an out-of-register colors correction amount (i.e., positional deviation value ΔZ in sub-scanning direction) is computed and stored in the memory 342.

The CPU 341 compute a correction amount (or value) for correcting an out-of-register colors using information stored in the memory 342 or detection signals output by each of detection sensors, and then the CPU 341 controls a light emitting timing of LD (laser diode) and a deflection element to adjust a light beam condition in sub-scanning direction via the I/F 340 using computed amount for correcting out-of-register colors.

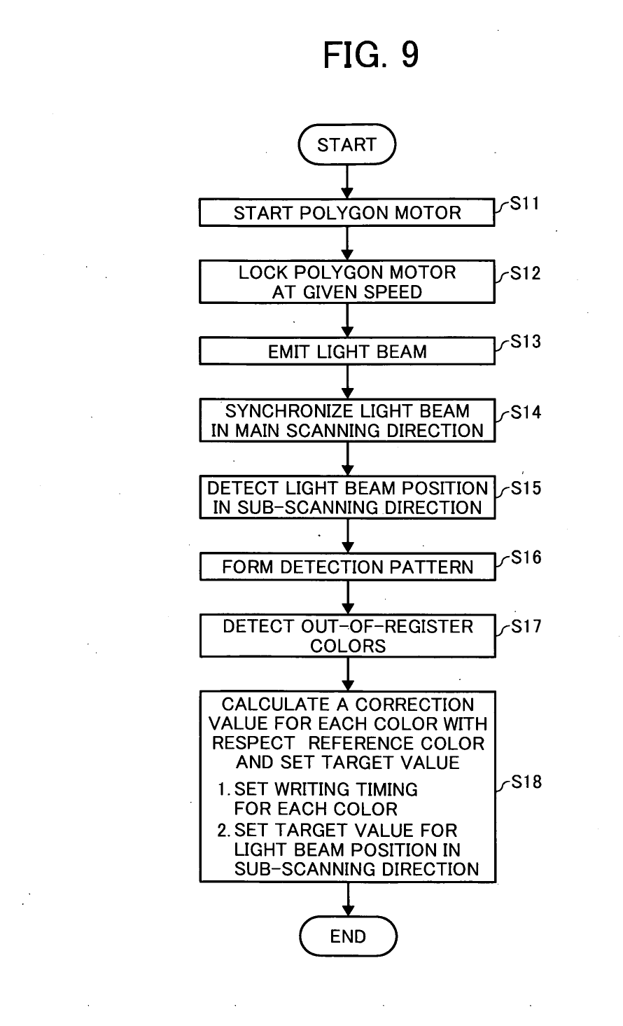

A description is now given to a process for setting a target value of light beam position in a sub-scanning direction with reference to FIG. 9. In such process, a detection pattern is formed to detect out-of-register colors, and a target value for light beam position in a sub-scanning direction is computed.

Out-of-register colors may be checked as below using detection patterns. At step S11, the polygon motor is activated and rotated, and after a rotation speed of the polygon motor becomes a given speed used for image forming, the rotation speed of the polygon motor is maintained at such speed at step S12 (referred as “polygon lock”). At step S13, a laser diode emits a light beam.

At step S14, each of light beams in a main scanning direction is detected and each of light beams is synchronized for scanning the photoconductor 10 based on input image data to set a writing timing of light beams to the photoconductor 10.

At step S15, a light beam position in a sub-scanning direction is measured by the first beam detection unit 300 or by both of the beam detection units 300 and 301. Because an optical face tangle error of polygon mirror for one rotation may slightly vary among each mirror face and a sensor has some reading error, the measurement times may be set to a value of multiplication of “polygon mirror face number (for one rotation)×n (whole number)” so that a light beam position in a sub-scanning direction can be correctly measured. In general, each of polygon mirror faces may have tiny variations for surface shape. Accordingly, by checking all faces of the polygon mirror, variations among polygon mirror faces may not effect to the beam detection process.

At step S16, detection patterns for checking out-of-register colors are formed for each monocolor. At step S17, detection patterns for each color are detected and light beam positions in sub-scanning direction corresponding to each color are detected.

At step S18, a deviation of each monocolor image with respect a reference monocolor image is determined to compute a correction amount for such image deviation. Specifically, a light beam position in a sub-scanning line for a reference monocolor image (e.g., black) and a measured timing for a reference monocolor are set as reference value.

Further, a time difference between a writing timing of a reference monocolor and a writing timing of each non-reference monocolor (i.e., in this case, yellow, cyan, magenta) is computed as delay timing of writing timing of each monocolor.

Light beam positions in a sub-scanning direction for the reference monocolor and each non-reference monocolor are stored in the memory 342 as target value with the above described delay timing. The target value of light beam position in a sub-scanning direction is a value used for correcting an image deviation for each monocolor. Specifically, based on the measured light beam positions for each monocolor, light beam positions in a sub-scanning direction for each monocolor are corrected based on a resolution of image forming process. For example, if an image forming process is conducted with a resolution of 600 dpi (dot per inch), such light beam position may be corrected by about 42 μm, corresponding one scanning line or one face of a polygon mirror. If such correction may need a resolution smaller than one scanning line, such light beam position may be corrected by less than 42 μm, smaller than one scanning line.

When a normal printing operation is conducted, a light beam position in a sub-scanning direction is measured at a given timing, and compared with a target value of light beam position in a sub-scanning direction stored in the memory 342 to detect and correct out-of-register colors.

A description is now given to a process of correcting out-of-register colors using a detection result of light beam position in a sub-scanning direction detected by the beam detection unit 300 (301).

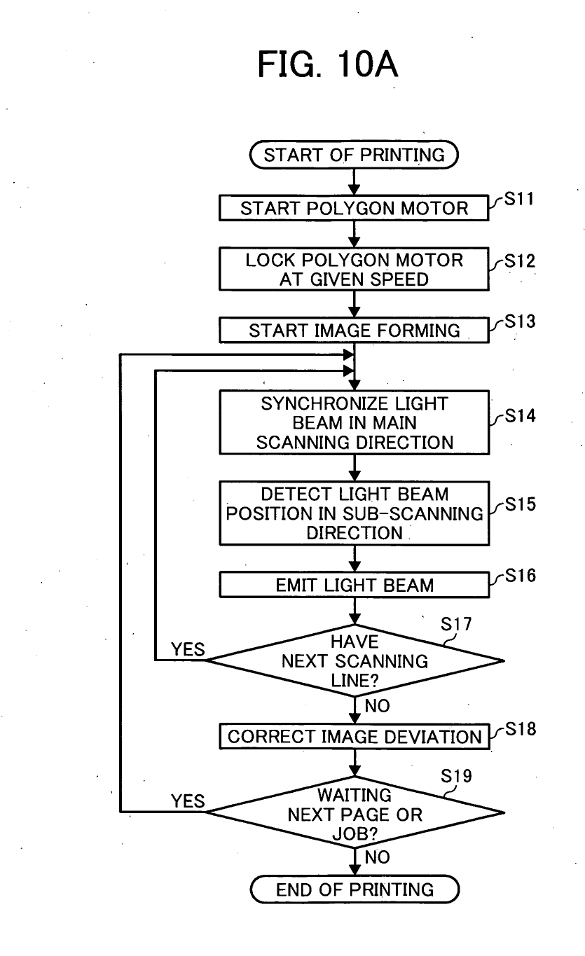

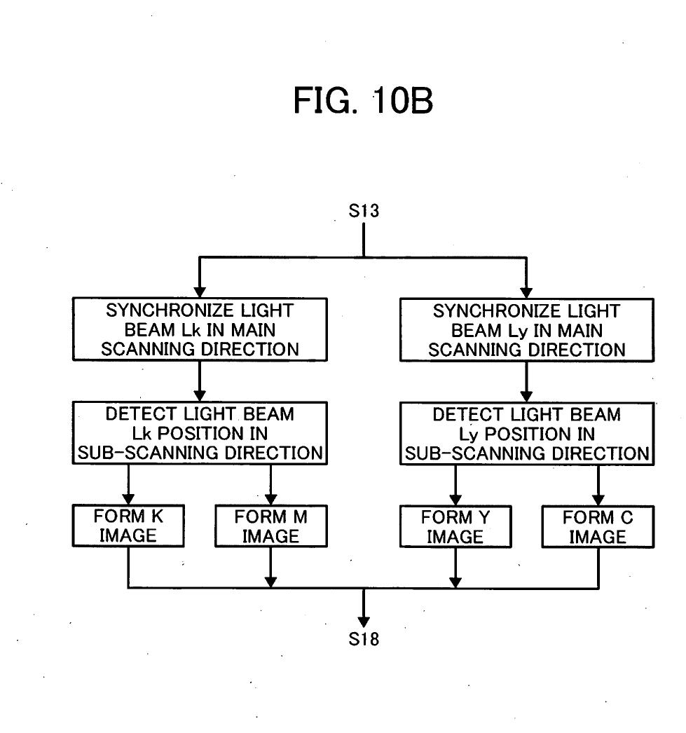

A description is now given to a process of correcting out-of-register colors when an image forming operation is conducted with reference to FIG. 10A. As illustrated in FIG. 10A, when a printing operation is started, a drive voltage is applied to the polygon motor (“polygon start”) at step S11, and a lock signal is detected (“polygon lock”) at step S12. When “polygon lock” is detected at step S12, an image forming process starts at step S13.

At step S14, the light source units 21K/21Y emits the light beams Lk/Ly, and the first beam detection units 300KM and 300YC detects the light beams Lk/Ly to synchronize the light beams Lk/Ly in a main scanning direction so that an image forming can be started from a correct position, and simultaneously the light source units 21M/21C emits the light beams Lm/Lc to start an image writing for images of M and C. At step S15, light beam positions of the light beams Lk/Ly are detected, and then a light beam used for image forming is emitted at step S16. At step S17, it is determined whether a next scanning is required.

An image writing for images of M and C starts by computing an image forming start timing for M and C using a synchronization detection signal for the light beams K and Y in a main scanning direction, in which, an image forming start timing, which is corrected by a known color position correction method for image registration correction in a main scanning direction, may be preferably used. For example, an image forming start timing may be set to a given value which is set in advance based on a known color position correction method using a detection pattern formed on an intermediate transfer belt for detecting positional deviation of images in a main scanning direction.

The aforementioned synchronization timing of the light beams Lk and Ly are routinely detected during an image forming operation, in which a light beam position of the light beams Lk and Ly in a sub-scanning direction are detected by the first beam detection units 300KM/300YC and the last beam detection units 301KM/301YC as shown in steps S14 to S17 in FIG. 10.

After completing an image forming operation, the process goes to step S18, and a target value for a light beam position in a sub-scanning direction stored in the memory 342 and a measurement value of light beam position in a sub-scanning direction for light beams (e.g., Ly, Lc, Lm) are compared to compute a correction amount ΔZ for correcting out-of-register colors, and a light beam position in a sub-scanning direction for the light beams (e.g., Ly, Lc, Lm) is corrected using the correction amount ΔZ. The correction amount ΔZ is computed by averaging measured sample values, in which sample number is defined by a multiplication of “polygon mirror face number (one rotation)×n (whole number)” for each light beam respectively, and the out-of-register colors can be corrected using the averaged value.

Light beam positions in a sub-scanning direction can be corrected based on a resolution of image forming process as above described. For example, a light beam position may be corrected with a resolution corresponding one scanning line or one face of a polygon mirror, or a resolution smaller than one scanning line. When a light beam position is corrected with a resolution corresponding one scanning line of a deflector (e.g., polygon mirror), a light emitting timing of a light beam by the light source unit 21 is adjusted.

Further, a correction amount ΔZ for out-of-register colors can be computed based on a detection result detected by any one of the beam detection units 300 and 301, or a correction amount ΔZ for out-of-register colors can be computed based on detection results detected by the both beam detection units 300 and 301, in which detection values detected by the beam detection units 300 and 301 are averaged to compute a correction amount ΔZ. However, it is preferable to use a correction amount ΔZ computed based on detection results of the both beam detection units 300 and 301.

If an out-of-register colors is corrected using a correction amount ΔZ, which is computed based on detection result of any one of the beam detection units 300 and 301, any one of the start position and end position of the light beam can be adjusted to a target position, but other one of the start position and end position of the light beam may not be adjusted to a target position. In such a case, out-of-register colors at any one of the start position and end position of the light beam may become undesirable level.

On one hand, if an out-of-register colors is corrected using a correction amount ΔZ, which is computed based on detection results of both the beam detection units 300 and 301, the center position of the light beam can be set to a target position while the start position and end position of the light beam are respectively deviated from a target position, in which such deviation amount for the start position and end position of the light beam may be same amount. However, compared to a case correcting out-of-register colors using a correction amount ΔZ computed based on a detection result of any one of the beam detection units 300 and 301, the start position and end position of the light beam may not deviated from a target position so greatly. Accordingly, compared to a case correcting out-of-register colors using a correction amount ΔZ computed based on a detection result by one beam detection unit, out-of-register colors due to an inclination of light beam can be suppressed when a correction amount ΔZ is computed based on detection results of both beam detection units.

Further, although synchronization detection of light beam in a main scanning direction for determining the start position for image forming is conducted using the light beams Lk and Ly in the above description, the light beams Lm and Lc can be used instead. As shown in FIG. 10B, the above-described process for image forming may be simultaneously conducted for each monocolor image, for example.

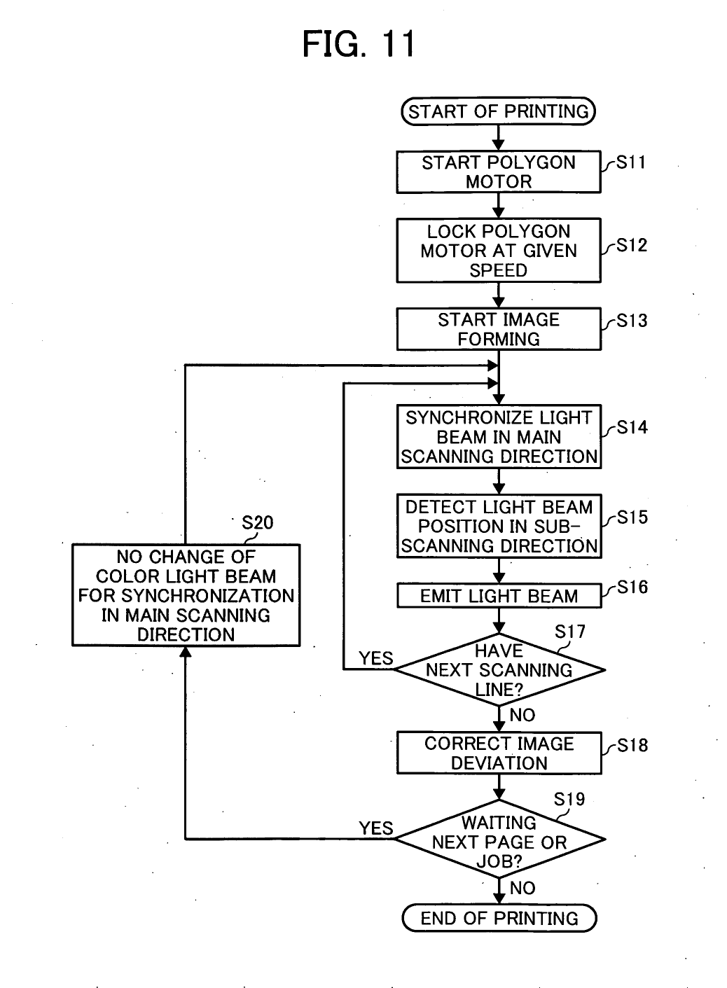

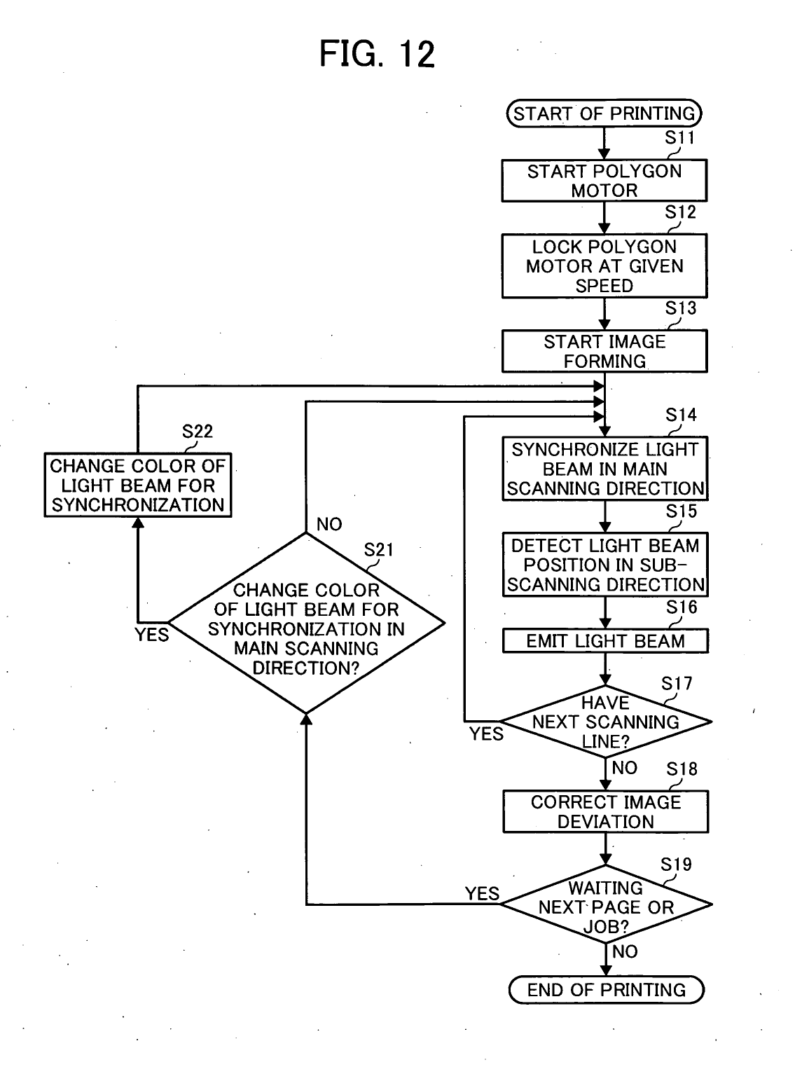

Further, as illustrated in FIG. 11, when a next job of a next page is waiting (yes at step S19), a determining step for changing a light beam for detecting a synchronization timing in a main scanning direction may be further added. As above described, a synchronization detection of light beam in a main scanning direction and a light beam position detection in a sub-scanning direction are conducted with a same light beam. Accordingly, if such detections are conducted with only the light beam Lk, a light beam position in a sub-scanning direction for the light beam Lm cannot be detected. If such condition may continue, a light beam position for the light beam Lm may deviate from a target position. Accordingly, steps S20 and S21 are respectively added in FIGS. 11 and 12 to cope with such drawbacks. In case of FIG. 11, a light beam for detecting a synchronization timing in a main scanning direction light beam is not changed at step S20.

Further, as illustrated in FIG. 12, when a next job of a next page is waiting (Yes at step S19), step 21 used for determining a changing of a light beam for detecting a synchronization timing in a main scanning direction may be further added, and a light beam for detecting a synchronization timing in a main scanning direction is changed at step 22, by which a laser beam used for a synchronization detection of light beam in a main scanning-direction and a light beam position detection in a sub-scanning direction are changed. For example, if the light beams Lk and Ly are used in one printing job, the light beams Lm and Lc may be used in a next printing job.

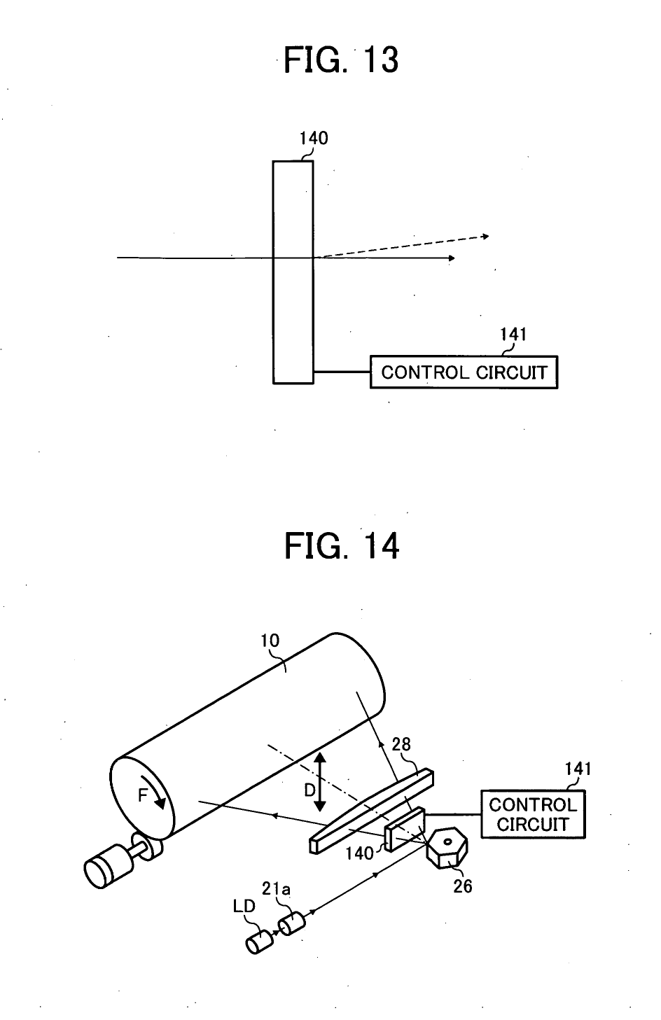

A description is now given to a deflection device for sub-scanning direction with reference to FIG. 13 to FIG. 16 illustrating example configurations of the deflection devices for sub-scanning direction.

As illustrated in FIG. 13, the deflection device for sub-scanning direction includes a liquid crystal element 140 and a control circuit 141, in which the control circuit 141 applies a given voltage to the liquid crystal element 140. The liquid crystal element 140 may be disposed between a light source unit 21 such as LD (laser diode) for emitting a light beam and the polygon scanner 130, or may be disposed between the polygon scanner 130 and the scan lens 28a and 28b.

For example, FIG. 14 illustrates a positional relationship of the light source LD, the collimate 21a, the polygon mirror 26, the liquid crystal element 140, the control circuit 141, and the scan lens 28 disposed in the optical scanning unit 20. The liquid crystal element 140 is disposed between the polygon mirror 26 and the scan lens 28. A light beam deflected by the polygon mirror 26 scans the photoconductor 10, in which a light beam position in a sub-scanning direction shown by an arrow D (see FIG. 14) can be corrected by using the liquid crystal element 140.

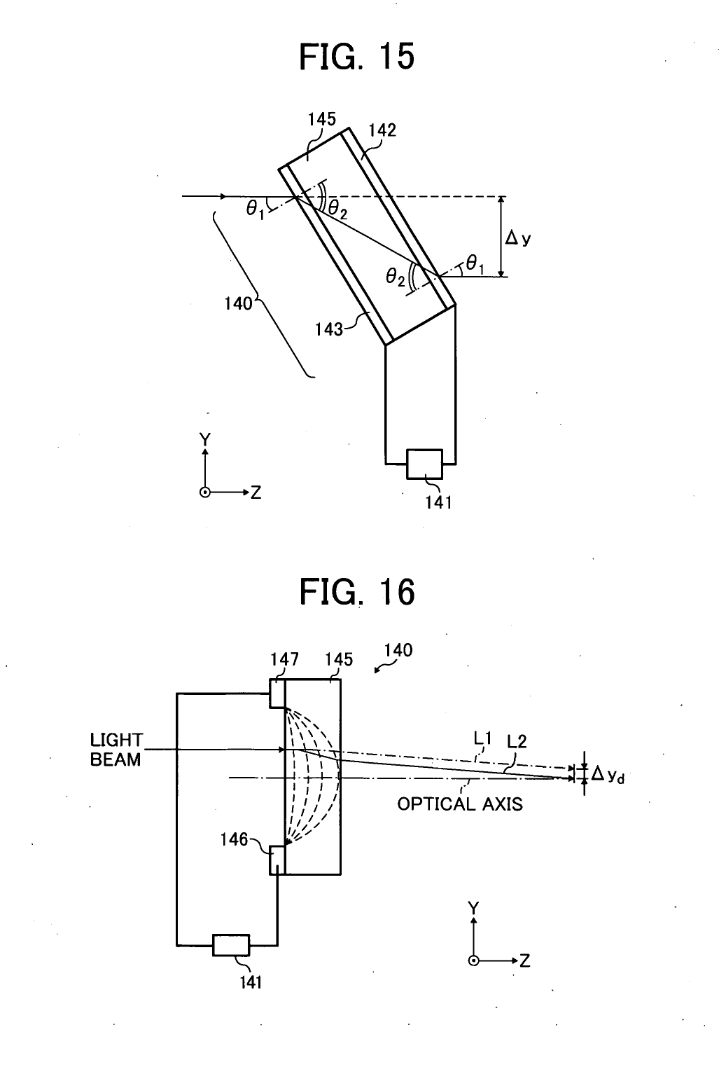

As illustrated in FIG. 15, the liquid crystal element 140 includes electrode substrates 142 and 143 and a liquid crystal layer 145, for example. When the control circuit 141 applies a given potential difference to the electrode substrates 142 and 143, a prism effect may be the generated in the liquid crystal layer 145, by which a light beam position in a sub-scanning direction can be corrected because a light beam entered the liquid crystal layer 145 can shift its position in a parallel direction when the light beam outgoes from the liquid crystal layer 145 by a prism effect.

Further, as illustrated in FIG. 16, the liquid crystal element 140 includes the liquid crystal layer 145, the control circuit 141, and electrodes 146 and 147 provided at a light beam incoming side of the liquid crystal layer 145. When the control circuit 141 applies a given potential difference to the electrodes 146 and 147, a lens effect of convex lens may be generated to the liquid crystal layer 145, by which a light beam is inflected when passing through the liquid crystal layer 145. With such configuration, a light beam position in a sub-scanning direction can be corrected.

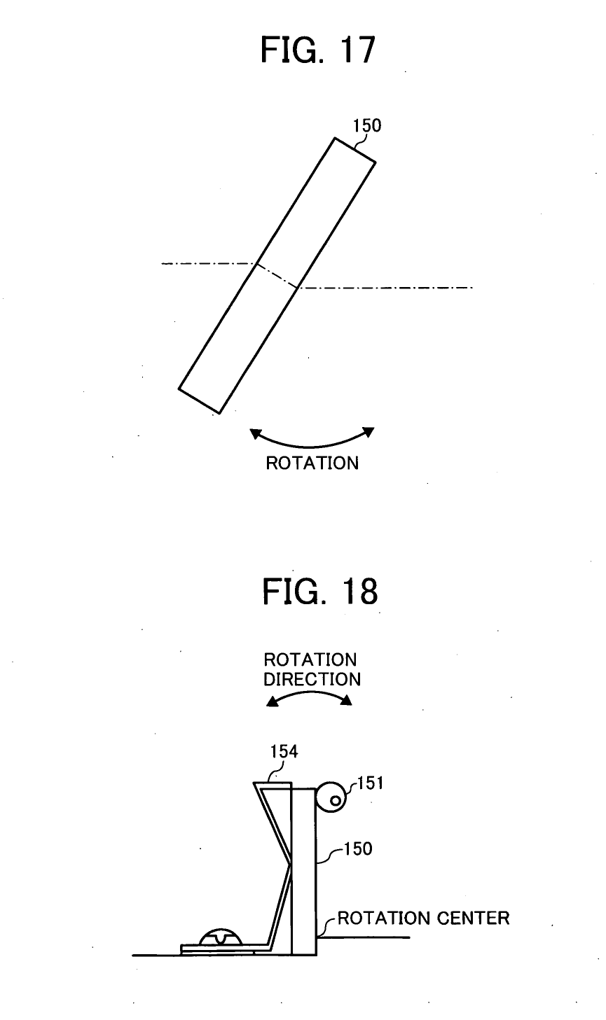

Further, as shown in FIG. 17, a parallel plate 150 can be used as another known deflection device for sub-scanning direction, for example. A light beam can pass through the parallel plate 150, which is rotatable at an axis, parallel to a main scanning direction. The parallel plate 150 may be disposed between the light source LD and the polygon mirror 26, or between the polygon mirror 26 and the scan lens 28. By entering a light beam to the parallel plate 150 slanted by rotation, a light beam position in a sub-scanning direction can be corrected.

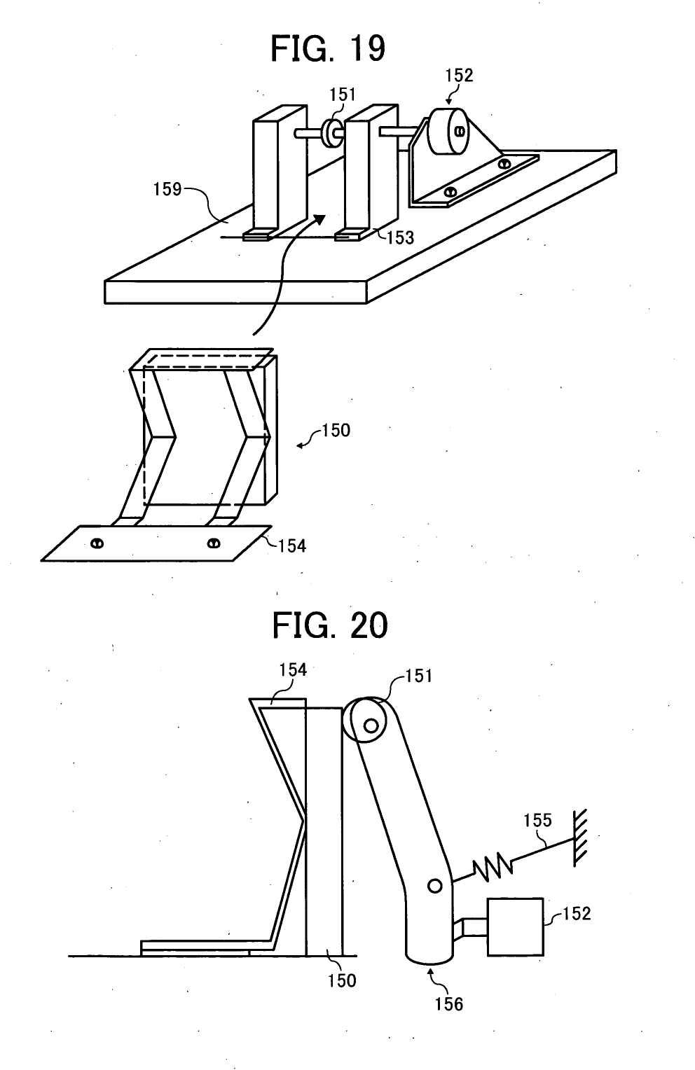

FIG. 18 illustrates a partial cross-sectional view of a deflection device for sub-scanning direction having the parallel plate 150, and FIG. 19 illustrates a perspective view of the deflection device for sub-scanning direction. The deflection device for sub-scanning direction includes a decentration cam 151, an actuator 152 such as stepping motor, a plate holding face 153, a leaf spring 154, a rotation shaft 159, and the parallel plate 150, for example.

The parallel plate 150 has two portions at its bottom side abutted to a receiving element, and one face of upper side of the parallel plate 150 is pressed by the decentration cam 151 and the other side of the parallel plate 150 is pressed by the leaf spring 154. The decentration cam 151 is connected to the actuator 152.

When the actuator 152 drives the decentration cam 151 to rotate, the decentration cam 151 moves and rotates the upper side of the parallel plate 150 in a direction shown by an arrow (see FIG. 18). In such rotation, the parallel plate 150 rotates about an axis passing through two portions at its bottom side abutted to the receiving element. Further, such rotation center may not need to be on an optical axis.

FIG. 20 illustrates another deflection device for sub-scanning direction, in which a filler is added to a cam shaft of the decentration cam 151. The decentration cam 151 can be rotated by moving the filler, by which the parallel plate 150 can be rotated. A light beam, entered, the slanted parallel plate 150 and outgoing from the parallel plate 150, may deviate from the entered light beam in sub-scanning direction and parallel to the entered light beam, and the deviation amount of the light beam is proportional to a rotation angle of the parallel plate 150.

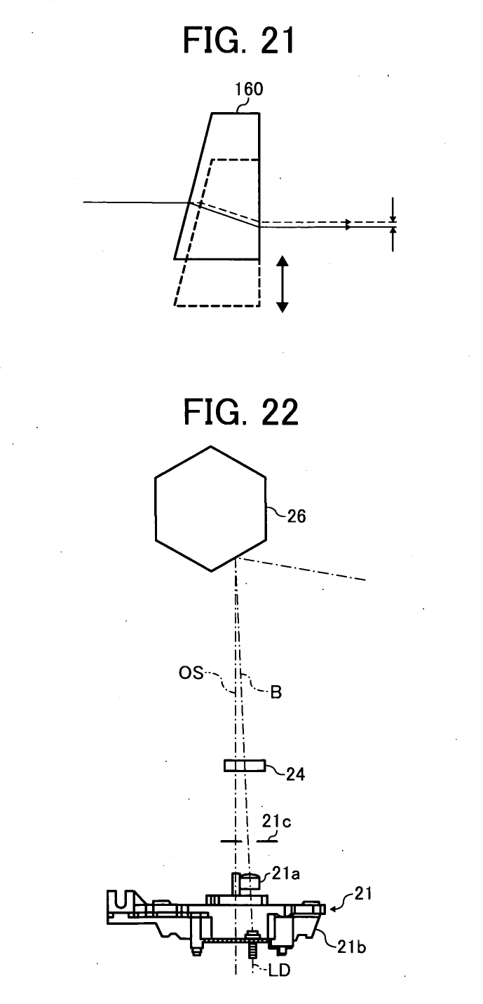

Further, instead of using the parallel plate 150, a prism 160 can be arranged as illustrated in FIG. 21, wherein the prism 160 may have a cross sectional shape of trapezoid. In such configuration, the prism 160 can be shifted in a given position in a parallel manner by moving the prism 160 in a sub-scanning direction shown by an arrow in FIG. 21 to correct a light beam position in a sub-scanning direction. Further, the prism 160 may be provided with an actuator shown in FIG. 19.

Further, as illustrated in FIG. 22, another known deflection device for sub-scanning direction can be used, in which an LD unit 21 includes a laser emitting element LD, a collimate 21a, and a support member 21b that supports the laser emitting element LD and the collimate 21a. A light beam B emitted from the laser emitting element LD passes through the collimate 21a, an aperture 21c, and a cylinder lens 24, and then enters a polygon mirror 26.

The LD unit 21 is rotatably attached to the housing 100 for housing the polygon mirror 26 and optical elements used for irradiating the light beam B to the photoconductor 10. Further, a rotation axis OS of the LD unit 21 and an optical axis of the light beam B may be deviated in a main scanning direction for a given deviation amount each other. Further, the rotation axis OS of the LD unit 21 and the optical axis of the light beam B are substantially matched at a deflection position on the polygon mirror 26.

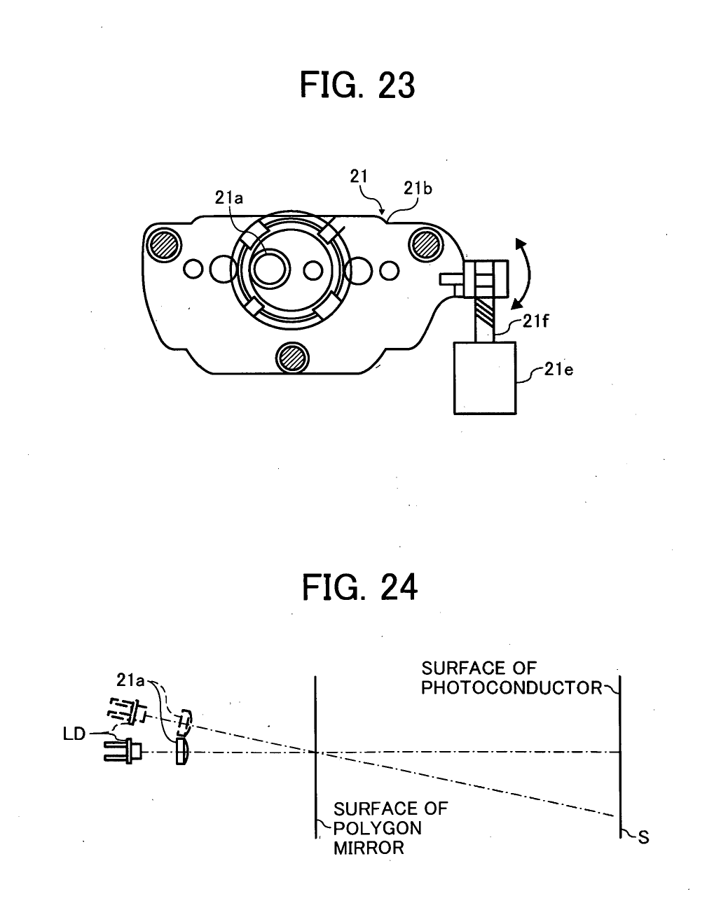

Further, as illustrated in FIG. 23, the LD unit 21 is provided with a beam position adjusting motor 21e and a lead screw 21f. The LD unit 21 is connected to the beam position adjusting motor 21e via the lead screw 21f, which is provided at one end in a main scanning direction. When the beam position adjusting motor 21e rotates, the lead screw 21f rotates. Then, the LD unit 21 rotate about the rotation axis OS of the LD unit 21 in a direction shown by an arrow in FIG. 23.

When the LD unit 21 rotates about the rotation axis OS of the LD unit 21, the LD unit 21 having the laser emitting element LD, optical elements and the support member 21b change its position in a sub-scanning direction as illustrated in FIG. 24, by which a laser irradiation position moves.

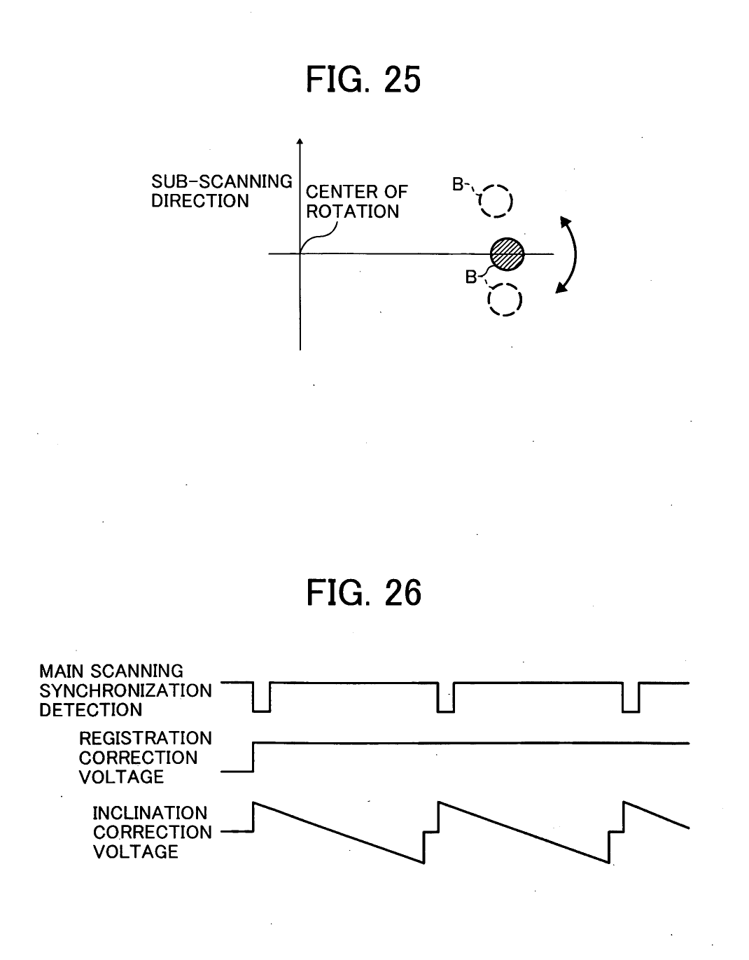

As a result, as illustrated in FIG. 25, the light beam B emitted from the laser emitting element LD shifts its position about the rotation axis OS of the LD unit 21 in a sub-scanning direction on the photoconductor 10, by which a laser irradiation position is shifted. As such, by rotating the LD unit 21 about the rotation axis OS of the LD unit 21, a beam position in a sub-scanning direction can be correctly controlled, and the out-of-register colors can be corrected with a higher precision.

A description is given to a method of correcting an inclination of light beam. In general, an apparatus installment condition or ambient temperature of an image forming apparatus may cause fluctuation of scanning line inclination for each beam used for each monocolor image, and such fluctuation may result in out-of-register colors in a sub-scanning direction.

In a conventional correction method, a plurality of rows (e.g., at least two rows) of detection patterns are formed on an intermediate transfer belt, and a plurality of pattern detection sensors (e.g., pattern detection sensor 330) are respectively disposed to detect each of the detection patterns. With such detection configuration, out-of-register colors due to inclination of color images among different monocolor images can be measured. Then, an inclination amount of each of monocolor images with respect to a reference monocolor is computed. Then, based on the computed inclination amount, an inclination of light beam can be corrected by a deflection device for sub-scanning direction.

Specifically, an inclination amount is computed for each monocolor, and the computed inclination amount becomes a correction amount. Based on such correction amount, a voltage to be applied to a deflection element is determined. A voltage pulse pattern for inclination correction is changed during one line scanning as shown in FIG. 26, and such voltage pulse for inclination correction is repeatedly supplied to the deflection element at a timing of detecting a synchronization signal in a main scanning direction.

In an example embodiment, instead of using the pattern detection sensor 330, the beam detection units 300 and 301 are also used as inclination detector, and based on a detection result of the beam detection units 300 and 301, an inclination of light beam may be corrected. Specifically, based on two position (e.g., the start and end of scanning by the light beam) values of one light beam in a sub-scanning line detected respectively by the beam detection units 300 and 301, an inclination amount of one monocolor image is determined, and an inclination of light beam can be corrected depending on such inclination amount.

An inclination correction may be conducted when a difference of a deviation or correction amount ΔZ1, computed based on a measurement result of the first beam detection unit 300, and a deviation or correction amount ΔZ2, computed based on a measurement result of the last beam detection unit 301, becomes greater than one scanning line. For example, a scanning line inclination can be adjusted by dividing image information in one scanning line and by changing a writing timing. Further, a scanning line inclination adjuster can be used to adjust an inclination as below.

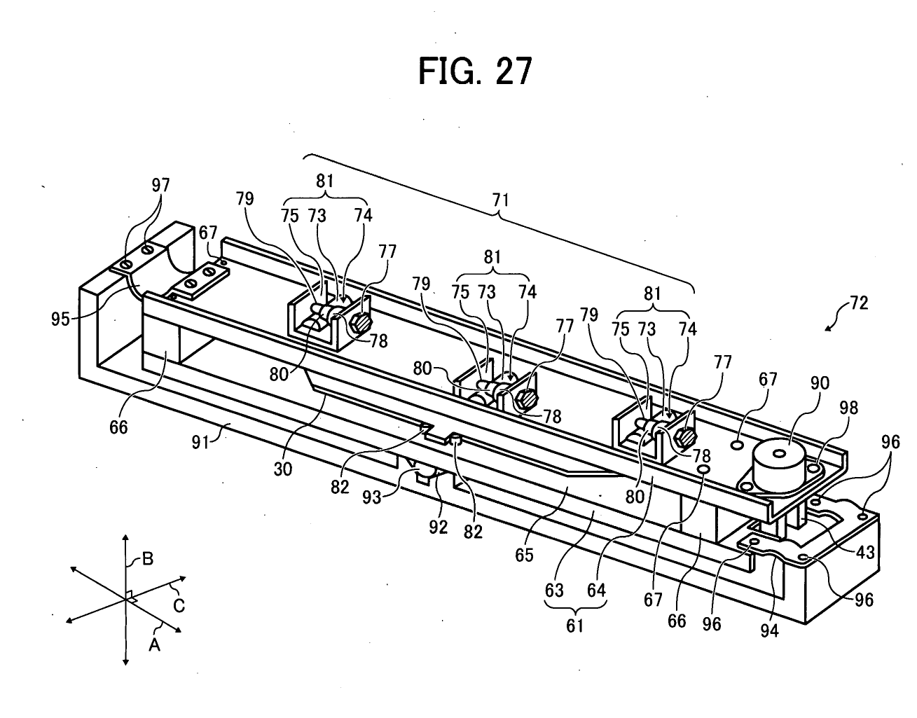

FIGS. 27 to 29 illustrate a configuration of a known scanning line inclination adjuster for correcting scanning line inclination. As illustrated in FIG. 27, the optical scanning unit 20 includes a scanning line bending corrector 71 and a scanning line inclination corrector 72. The scanning line bending corrector 71 is used to correct a bending of light beam (or scanning beam) on the photoconductor 10 by correcting a position of the long lens 30 in a sub-scanning direction B. The scanning line inclination corrector 72 is used to correct an inclination of light beam (or scanning beam) on the photoconductor 10 by inclining the long lens 30 as a whole.

Some parts configuring the scanning line bending corrector 71 and some parts configuring the scanning line inclination corrector 72 are integrated to the holding member 61. Further, the scanning line bending corrector 71 and the scanning line inclination corrector 72 may be disposed for each of the long lens 30K, 30M, 30C, and 30Y.

The holding member 61 includes a first support member 63 and a second support member 64. The first support member 63, extending in a main scanning direction A, supports the long lens 30 from the sub-scanning direction B. The second support member 64 is used with the first support member 63 to hold the long lens 30 therebetween. As shown in FIG. 27, the first support member 63 includes a reference face 65, which contacts the long lens 30 to set a reference position for the long lens 30 in the holding member 61.

The first and the second support members 63 and 64 shown in FIG. 29 are made of a steel plate, for example, wherein the steel plate is bended and shaped in U-shaped form in cross section to increase a bending strength, and a flat face of the U-shaped form of the first and the second support members 63 and 64 is abutted to the long lens 30. The abutted face of the first support member 63 is used as the reference face 65 for the long lens 30. The long lens 30 is fixed on the reference face 65 of the first support member 63 with pins 82 projected from the reference face 65, wherein the pins 82 sandwich the long lens 30 at a given position.

As shown in FIG. 27, a rectangular column 66 is disposed at both end portion of the first and second support members 63 and 64 in a main scanning direction A for the long lens 30. By interposing the rectangular column 66 having a height substantially similar to a thickness of the long lens 30, the first and second support members 63 and 64 are fixed each another while maintaining a given interval therebetween.

In a condition that the first and second support members 63 and 64 sandwich the long lens 30, the first support member 63 and the rectangular column 66 are fixed with screws 67, and the second support member 64 and the rectangular column 66 are fixed with screws 67, respectively. As such, the rectangular column 66 is used as a part configuring the holding member 61 in addition to the first and second support members 63 and 64. FIG. 27 shows the screws 67 fixing the second support member 64 and the rectangular column 66. A description of the scanning line bending corrector 71 is omitted.

The scanning line inclination corrector 72 has a following driving configuration to incline the holding member 61, wherein such driving configuration may be integrated to the second support member 64. For example, the scanning line inclination corrector 72 includes a stepping motor 90 and an inclination detector (not shown in FIG. 27). The stepping motor 90 is used as actuator or drive unit to incline the holding member 61, and inclination detector such as beam detection units 300 and 301 detects an inclination of scanning line.

The holding member 61 can be inclined by the stepping motor 90 depending on an inclination amount detected by the inclination detector, corresponding to a positional deviation value of scanning line, so that the long lens 30 is inclined for correcting an inclination of light beam (or scanning beam). Such beam inclination correction may be controlled by a control unit (not shown) having a CPU (central processing unit), for example.

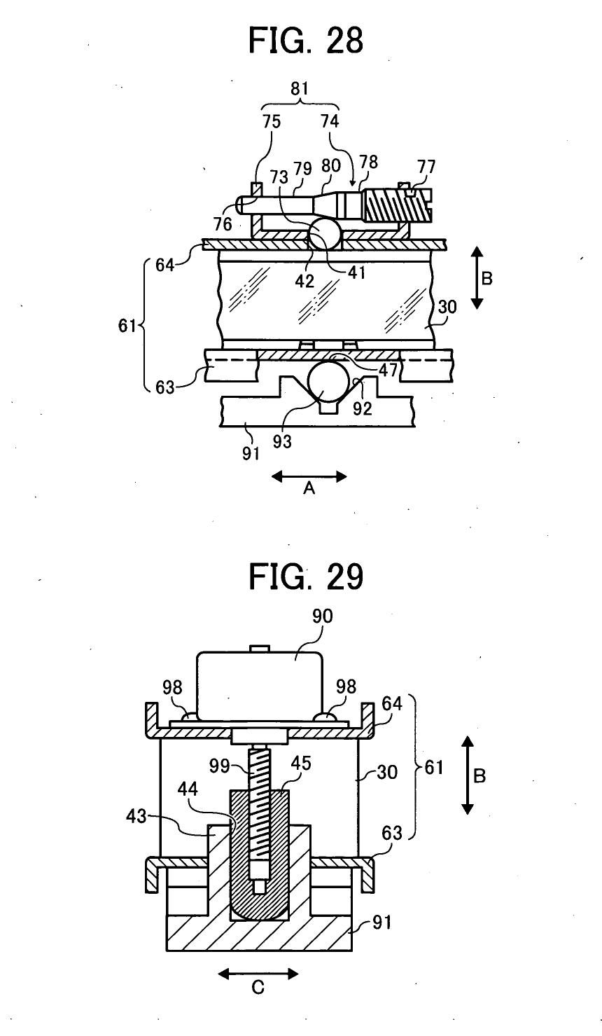

A long lens holder 91 shown in FIGS. 28 and 29, fixedly integrated to a housing (not shown) of the optical scanning unit 20, supports the holding member 61. Instead of using the long lens holder 91, the holding member 61 may be fixedly integrated to the housing of the optical scanning unit 20. As shown in FIG. 28 or FIG. 29, the long lens holder 91 includes a V-shaped groove 92, which extends in a direction C at a center of the long lens 30 with respect to the main scanning direction A.

The scanning line inclination corrector 72 includes a roller 93 placed in the V-shaped groove 92, wherein the roller 93 is long in the direction C.

The holding member 61, supported by the long lens holder 91 via the roller 93, can change its inclination in a given direction to correct an inclination of scanning line because the holding member 61 is movably supported by the roller 93 provided for the long lens holder 91. Accordingly, a contact portion of the roller 93 and the holding member 61 is used as a fulcrum 47 for inclining the holding member 61. The fulcrum 47 is at a center position of the long lens 30 in the main scanning direction A, and near an optical axis of the long lens 30.

However, if the holding member 61 is supported only by the roller 93 of the long lens holder 91, the holding member 61 may not be stably supported. In view of such situation, the scanning line inclination corrector 72 includes a first leaf spring 94 and a second leaf spring 95 as shown in FIG. 27. The first leaf spring 94 made of elastic member is integrated to the first support member 63 and the long lens holder 91. The second leaf spring 95 made of elastic member is integrated to the second support member 64 and the long lens holder 91. With such configuration, the holding member 61 can be movably supported by the long lens holder 91 so that the holding member 61 can be moved in a given direction to correct an inclination of a scanning line. Further, with the elastic force of the first and the second leaf springs 94 and 95, the holding member 61 can be pressed toward the long lens holder 91 via the roller 93, and thereby the holding member 61 can be stably supported by the long lens holder 91.

The first leaf spring 94 is integrated to the first support member 63 and the long lens holder 91 with screws 96, and the second leaf spring 95 is integrated to the second support member 64 and the long lens holder 91 with screws 97. The stepping motor 90 is integrated to the second support member 64 with screws 98.

As illustrated in FIG. 29, the stepping motor 90 includes a stepping motor shaft 99, and the long lens holder 91 includes a projected portion 43 having a groove 44 therein, wherein the projected portion 43 projects from an upper face of the long lens holder 91. In such groove 44, a nut 45 having U-shaped form is engaged. The stepping motor shaft 99 has male screws thereon, and a leading edge of the stepping motor shaft 99 is meshed with the nut 45. Because the nut 45 can be fixed in the groove 44, the nut 45 does not move when the stepping motor shaft 99 rotates.

Based on a positional deviation value for scanning line detected by the beam detection units 300 and 301 (used as inclination detector), the CPU computes drive signal (e.g., drive pulse) for driving the stepping motor 90, and drives the stepping motor 90. The aforementioned detection pattern is formed at a given timing and detection signal detected by an inclination detector is used for a feedback control by the CPU of the control unit.

The CPU drives the stepping motor 90 based on relative positional deviation in a sub-scanning direction (or correction amount ΔZ in a sub-scanning direction) detected by the beam detection units 300 and 301. When the stepping motor 90 is driven, the stepping motor shaft 99 rotates, by which the holding member 61 change its position with respect to the long lens holder 91 against the biasing force of the leaf springs 94 and 95, by which the holding member 61 inclines about the fulcrum 47 as a inclination center.

Because the CPU controls a feedback control for driving the stepping motor 90 based on a detection result detected by the beam detection units 300 and 301, a positional deviation of scanning line or an inclination of scanning line can be adjusted in a timely manner.

Further, in the optical scanning unit 20, one of the monocolor of yellow (Y), magenta (M), cyan (C), and K (black) is used as reference monocolor, and a scan position of light beam for colors other than the reference monocolor is corrected so that the scan position for other monocolors can be adjusted to a scan position of light beam for the reference monocolor. In other words, a scanning line of light beam for non-reference monocolor is matched to a scanning line of light beam for reference monocolor, by which a correction of relative scanning line position for different monocolors can be conducted, and a change of color tone can be effectively suppressed and an image having higher color reproducibility can be obtained.

Accordingly, the scanning line bending corrector 71 and the scanning line inclination corrector 72 may be disposed for any three light beams among the light beams for yellow (Y), magenta (M), cyan (C), and K (black), by which three scanning line bending correctors 71 and three scanning line inclination correctors 72 are disposed if four monocolors are used for image forming, for example. The reference monocolor may be black, for example.

Further, although two polygon mirrors (i.e., upper and lower polygon mirrors 26 and 27) are used to respectively deflect light beams emitted from a plurality of light sources (i.e., four light sources) to deflect and scan respective light beams to respective photoconductors in the above-described example embodiment, each of light sources can be provided with a polygon mirror.

In the above-described example embodiment, in the optical scanning unit 20, light beams of each monocolor enter a same beam detector (e.g., detection unit 300 or 301), and the beam detection unit 300 (301) detects a light beam position in a sub-scanning direction. Accordingly, a number of beam detection units can be reduced compared to a configuration disposing a beam detection unit for each one of light beams, by which a light beam position in a sub-scanning line can be detected with an apparatus manufactured with a reduced cost.

Further, light beams of each monocolor enter and reflect on a same reflection mirror, and then enter a beam detection unit in an exemplary embodiment. Accordingly, compared to a configuration disposing different reflection mirrors for each one of light beams, an error of beam spot diameter of light beams irradiated to a light receiving element of a beam detection unit can be reduced in an exemplary embodiment.

Further, in the above-described example embodiment, the optical scanning unit 20 includes the first beam detection unit 300 and the last beam detection unit 301, wherein the first beam detection unit 300 detects a scanning start position of light beams, and the last beam detection unit 301 detects a scanning end position of light beams. Accordingly, a light beam position in a sub-scanning direction at the scanning start position and a light beam position in a sub-scanning direction at the scanning end position can be detected. Based on light beam positions in a sub-scanning direction at the scanning start position and at the scanning end position, an inclination of light beam can be detected.

Further, by measuring a time period or difference between a light beam detection timing by the first beam detection unit 300 and a light beam detection timing by the last beam detection unit 301, a magnification of one scanning line in a main scanning direction can be determined.

Further, based on a detection result detected by a beam detection unit, a positional deviation value ΔZ in a sub-scanning direction can be computed, and based on the computed positional deviation value ΔZ, a positional deviation of light beam in a sub-scanning direction can be corrected. Accordingly, positional deviation in a sub-scanning direction can be corrected without forming detection image pattern on an intermediate transfer belt.

Further, based on the measured light beam positions for each monocolor, light beam positions in a sub-scanning direction for each monocolor is corrected based on a resolution of image forming process, by which positional deviation of among monocolor images can be corrected by one scanning line or less than one scanning line.

Further, a light beam position in a sub-scanning direction can be detected by a plurality of times by a beam detection unit to compute a positional deviation value by averaging detection results. By conducting a positional deviation correction based on such computed positional deviation value, a variation such as detection error by a beam detection unit can be reduced, and a positional deviation in a sub-scanning direction of light beam can be corrected precisely.

In the above-described optical scanning unit, a plurality of light beams deflected by a polygon mirror can enter a common beam detector with a same incoming angle, by which a number of beam detectors can be reduced, and thereby an optical scanning unit can be manufactured with reduced cost.

If the incoming angle is not same for a plurality of light beams (e.g., two light beams), two light beams coming to the beam detector pass slightly different position when deflected by a polygon mirror and when passing through a cylinder lens, by which light beam property such as beam spot diameter at the beam detector may become different between the two light beams. In such a case, a condenser lens may need to be positioned after the cylinder lens to detect light beams precisely, for example. The above-described optical scanning unit according to an example embodiment does not need such condenser lens, by which the optical scanning unit can be manufactured with lesser number of parts, and thereby optical scanning unit can be manufactured with reduced cost.

If the incoming angle is not same for two light beams, a given amount of difference is in need for two incoming angle although such difference is tiny in scale. Accordingly, two light beams reach the beam detector with some time difference. If such time difference is too small, a first light beam firstly reaching the beam detector and a second light beam reaching the beam detector after the first light beam overlap each other, by which the beam detector cannot determine which beam comes first.

However, in the above-described optical scanning unit, the incoming angle is set same for two light beams entering the polygon mirror, by which the optical scanning unit employ a simpler optical system for light beam detection.

If the incoming angles between two light beams have some tiny difference, such two light beams coming to the beam detector pass slightly different position when deflected by a polygon mirror and when passing through a cylinder lens. Accordingly, the greater the difference of the incoming angles, each of two light beams need a greater optical path to reach the beam detector.

However, because the above-described optical scanning unit has an optical system that two light beams has a same incoming angle, the optical scanning unit can be manufactured with compact in size.

Further, in the above-described optical scanning unit, a plurality of light beam generators can be disposed so as to emit light beams in a same direction, by which a plurality of light beam generators emit light beams with a same angle. Accordingly, an optical scanning unit can employ a simpler optical system for light beam detection compared to a conventional configuration, which need a slight difference for incoming angle of light beams.

Further, in the above-described optical scanning unit, because a plurality of light beam generators is attached to a common control board, a control unit and other elements can be commonly used for a plurality of light beam generators, by which an optical scanning unit can be compact in size and can be manufactured with reduced cost.

Further, in the above-described optical scanning unit, light beams deflected by the polygon mirror can be reflected by a common reflection mirror before entering a beam detector. Accordingly, a plurality of light beams can be irradiated with higher precisely compared to using different reflection mirrors

Further, in the above-described optical scanning unit, different light beams can be detected by a common beam detector, by which the above-described optical scanning unit having a simpler configuration can be manufactured with reduced cost.

Further, an image forming apparatus employing the above-described optical scanning unit having a simple configuration can be manufactured with reduced cost.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An optical scanning unit for use with a first photosensitive member and a second photosensitive member, comprising:
a first light beam generator configured to emit a first light beam;
a second light beam generator configured to emit a second light beam;
a deflector configured to deflect the first light beam and the second light beam in a main scanning direction and to scan a surface of the first photosensitive member and the second photosensitive member using the first light beam and the second light beam, respectively;
a beam detector configured to detect both the first light beam and the second light beam deflected by the deflector and detect a light beam position of the first light beam and a light beam position of the second light beam in a sub-scanning direction; and
an optical element disposed along an optical path for the first light beam and an optical path for the second light beam starting from the first light beam generator to the deflector and the second light beam generator to the deflector, respectively,
the optical element making a light incoming angle of the first light beam striking the deflector and a light incoming angle of the second light beam striking the deflector the same,
each incoming angle defined by a light axis direction of either the first light beam or the second light beam and a normal line extending from the surface of either the first photosensitive member or the second photosensitive member.

2. The optical scanning unit according to claim 1, wherein the first light beam generator and the second light beam generator are disposed to emit the first light beam and the second light beam, respectively, in a same direction.

3. The optical scanning unit according to claim 2, wherein, the first light beam generator and the second light beam generator are attached to a same control board.

4. The optical scanning unit according to claim 1, wherein the first light beam and the second light beam deflected by the deflector are reflected by a common reflection mirror before the first light beam and the second light beam enter the beam detector.

5. An image forming apparatus, comprising:
a first photosensitive member;
a second photosensitive member; and
an optical scanning unit,
the optical scanning unit including:
a first light beam generator configured to emit a first light beam;
a second light beam generator configured to emit a second light beam;
a deflector configured to deflect the first light beam and the second light beam in a main scanning direction and to scan a surface of the first photosensitive member and the second photosensitive member using the first light beam and the second light beam, respectively;
a beam detector configured to detect both the first light beam and the second light beam deflected by the deflector and detect a light beam position of the first light beam and a light beam position of the second light beam in a sub-scanning direction; and
an optical element disposed along an optical path for the first light beam and an optical path for the second light beam starting from the first light beam generator to the deflector and the second light beam generator to the deflector, respectively,
the optical element making a light incoming angle of the first light beam striking the deflector and a light incoming angle of the second light beam striking the deflector the same,
each incoming angle defined by a light axis direction of either the first light beam or the second light beam and a normal line extending from the surface of either the first photosensitive member or the second photosensitive member.
